(19) United States
(12) Patent Application Publication
(10) Pub. No.: US 2010/0158249 A1
(43) Pub. Date: Jun. 24, 2010

(54) DATA TRANSMITTING APPARATUS AND DATA RECEIVING APPARATUS

(76) Inventors: Tsuyoshi Ikushima, Nara (JP); Masaru Fuse, Osaka (JP); Satoshi Furusawa, Osaka (JP); Tomokazu Sada, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/997,677

(22) PCT Filed: Sep. 21, 2006
(86) PCT No.: PCT/JP2006/318701

§ 371 Date: Feb. 1, 2008

(30) Foreign Application Priority Data
Oct. 11, 2005 (JP) 2005-296939

(51) Int. Cl. H04K 1/00

(52) U.S. Cl. 380/255

(57) ABSTRACT

Provided is a data communication apparatus which significantly increases time necessary for an eavesdropper to analyze cipher text and which is superior in concealability based on astronomical computational complexity. A multi-level signal, which is generated by using data and key information, has a minor amplitude modulation, which is based on a random number signal generated on a transmission side, overlapped thereon, and is then transmitted. On a receiving side, instead of data decision, three types of decision, i.e., “1”, “0” and “decision impossible”, are performed on a random number signal by using two threshold values whose interval is significantly wider than a modulation amplitude based on random numbers. Information of a bit whose decision is performed successively is returned to the transmission side, and the bit is used commonly as a new key. Accordingly, in a single transmitting/receiving apparatus, cipher text transmission and key distribution can be realized simultaneously.

### TECHNICAL FIELD

The present invention, relates to an apparatus for performing secret communication which prevents unauthorized eavesdropping/interception by a third party. More specifically, the present invention relates to an apparatus for performing data communication between legitimate transmitting and receiving parties by selecting/setting a specific encoding/decoding (modulating/demodulating) method.

### BACKGROUND ART

Conventionally, in order to perform communication between specific parties, there has been adopted a configuration in which original information (key information) for encoding/decoding is snared, between transmitting and receiving ends, mathematical operation/inverse operation is performed on information data (plain text) to be transmitted by using the information, and then secret communication is realized. FIG. 2B is a block diagram showing a configuration of a conventional data transmitting apparatus based on the configuration. As shown in FIG. 28, the conventional data communication apparatus includes a data transmitting apparatus 90001, a transmission line 913, and a data receiving apparatus 90002. The data transmitting apparatus 90001 is composed of an encoding section 911 and a modulation section 912. The data receiving apparatus 90002 is composed of a demodulation section 914 and a decoding section 915. When information data 90 and first key information 91 are inputted to the encoding section 911, and when second key information 96 is inputted to the decoding section 915, information data 98 is outputted from the decoding section 915. In order to describe eavesdropping by a third party, it is assumed, that FIG. 28 includes an eavesdropper data receiving apparatus 90003 which is composed of an eavesdropper demodulation section 916 and an eavesdropper decoding section 917. Third key information 99 is inputted to the eavesdropper decoding section 917. Hereinafter, with reference to WIG. 28, an operation of the conventional data communication apparatus will be described.

In the data transmitting apparatus 90001, the encoding section 911 encodes (encrypts) the information data 90 by using first key information 91. The modulation section 912 modulates the information data, which is encoded by the encoding section 911, into a modulated signal 94 in a predetermined modulation format so as to be transmitted to the transmission line 913. In the data receiving apparatus 90002, the demodulation section 914 demodulates, in a predetermined demodulation method, the modulated signal 94 transmitted via the transmission line 913, and outputs the encoded information data. The decoding section 915 decodes (decrypts) the encoded information data by using the second key information 96, which is shared with the encoding section 911 and is identical to the first key information 91, and then outputs original information data 98.

When the eavesdropper data receiving apparatus 90003 eavesdrops a modulated signal (information data) which is transmitted between the data transmitting apparatus 90001 and the data receiving apparatus 90002, the eavesdropper demodulation section 916 causes a part of the modulated signal transmitted through the transmission line 913 to be divided, to be inputted thereto, and to be demodulated in the predetermined demodulation method. The eavesdropper decoding section 917 then attempts to decode the same by using third key information 99. The eavesdropper decoding section 917 does not share key information with the encoding section 911. That is, the eavesdropper decoding section 917 performs decoding by using the third key information 99 which is different from the first key information 91, and thus cannot reproduce the original information data appropriately.

A mathematical encryption (or also referred to as a computational encryption or a software encryption) technique based on such a mathematical operation may be applied to an access system or the like as described, for example, in publication of patent document 1. In other words, in the case of a PON (Passive Optical Network) configuration in which an optical signal transmitted from one optical transmitter is divided by an optical coupler so as to be distributed to optical receivers at a plurality of optical subscribers' households, the optical signal only desired by and supposed to be directed to certain subscribers is inputted to all the optical receivers. Therefore, information data for respective subscribers is encoded by using key information which is different depending on the subscribers, whereby leakage/eaves dropping of mutual information may be prevented, and safe data communication may be realised.

Patent document 1: Japanese Laid-Open Patent Publication No. 9-205420
Non-patent document 1: “Cryptography and Network Security: Principles and Practice” translated by Keiiebiro Ishihashi et al., Pearson Education, 2001
Non-patent document 2: “Applied Cryptography” translated by Mayumi Adaohi et al., Softbank publishing, 2003

### DISCLOSURE OF THE INVENTION

### Problems to be Solved by the Invention

A method called stream encryption, among mathematical encoding methods, has a simple configuration in which cipher text is generated by performing an XOR operation between a pseudo random number series, which is outputted from a pseudo random number generator, and data to be encrypted (plain text), and is thus advantageous in terms of speed. On the other hand, security of the stream encryption only depends on the random number generator. That is, if an eavesdropper can obtain a combination of the plain text and the cipher text in a certain manner, the pseudo random number series may be identified accurately (, which is generally called as a known plain text attack). Further, an initial value of the pseudo random number generator, i.e., key information, and the pseudo random number series correspond to each other uniquely, and thus the key info mat ion may be calculated certainly by applying some decryption algorithm. Further, since processing speed of a computer is improving remarkably in recent years, a problem is posed in that there is an increasing danger of decryption of the cipher text within a practical time period.

Therefore, an object of the present invention is to apply an uncertain element to mutual relations between the key information and the pseudo random number series, and the cipher text, and accordingly to provide a highly concealable data communication apparatus which causes the eavesdropper to increase efforts necessary to analyse the cipher text, that is, which increases computational complexity, compared to the conventional stream encryption.

### Solution to the Problems

The present invention is directed to a data transmitting apparatus for performing encrypted communication. To achieve the above objects, the data transmitting apparatus of the present invention comprises a multi-level encoding section and a modulation section. The multi-level encoding section inputs thereto predetermined key information and information data, and generates a multi-level signal in which a signal level changes so as to be approximately random numbers. The modulation section generates a modulated signal in a predetermined modulation format in accordance with the multi-level signal.

The multi-level encoding section includes a multi-level code generation section and a multi-level processing section. The multi-level code generation section generates, by using the predetermined key information, a multi-level code sequence in which a signal level changes so as to be approximately random numbers. The multi-level processing section combines the multi-level code sequence and the information data in accordance with predetermined processing, and generates the multi-level signal having a level corresponding to a combination of the signal level of the multi-level code sequence and a signal level of the information data.

The multi-level code generation section includes a random number generation section, a bit-to-be-inverted selection section, a random number sequence bit inversion section, and a multi-level conversion section. The random number generation section generates a plurality of random number sequences by using the predetermined key information. The bit-to-be-inverted selection section outputs a bit-to-be-inverted selection signal for selecting a random number sequence on which bit inversion is to be performed, from among the plurality of random number sequences. The random number sequence bit inversion section outputs one or more random number sequences by performing the bit inversion thereof, among the plurality of the random number sequences, in accordance with a value of the bit-to-be-inverted selection signal. The multi-level conversion section, converts the plurality of random number sequences, including the random number sequence on which the bit inversion has been performed, into the multi-level code sequence.

A bit to foe inverted in the random number sequence bit inversion section satisfies a condition that a ratio between an information amplitude, which is equivalent to an amplitude of the information data, and a fluctuation range of the multi-level signal, which is equivalent to the bit to be inverted, is greater than a signal-to-noise ratio permissible by a legitimate receiving party.

The bit to be inverted in the random number sequence bit inversion section is selected from among bits except for a lowest-order bit.

Preferably, the bit-to-be-inverted selection section includes a random number generation section for generating bit-selecting random numbers which are predetermined random numbers; and a selection signal conversion section for converting the bit-selecting random numbers into the hit-to-be-inverted selection signal in accordance with values of the bit-selecting random numbers.

The bit-selecting random numbers generated in the random number generation section are genuine random numbers. Further, the number of bits of the multi-level code sequence is set equal to or lower than the number of bits of the key information.

Further the present invention is directed to a data receiving apparatus performing cipher communication. To attain the above-described object, the data receiving apparatus of the present invention comprises: a demodulation section for demodulating a modulated signal in a predetermined modulation format, and for outputting a multi-level signal; and a multi-level decoding section for outputting information data in accordance with predetermined key information and the multi-level signal. The multi-level decoding section includes: a multi-level code generation section for generating, by using the key information, a multi-level code sequence in which a signal level changes so as to be approximately random numbers; and a decision section for deciding the multi-level signal in accordance with the multi-level code sequence, and for outputting the information data. The multi-level code generation section includes: a random number generation section for generating a plurality of random number sequences by using the predetermined key information; and a multi-level conversion section for converting the plurality of random number sequences into the multi-level code sequence.

To the multi-level conversion section, a higher-order bit of the plurality of random number sequences is inputted, and a fixed value is inputted as a low-order bit.

Preferably, a ratio between information amplitude, which is equivalent to an amplitude of the information data, and a fluctuation range of the multi-level signal, which is equivalent to the low-order bit, satisfies a condition of being greater than a signal-to-noise ratio permissible by a legitimate receiving party.

### EFFECT OF THE INVENTION

A data communication apparatus of the present invention encodes/modulates information data into a multi-level signal by using key information, demodulates/decodes the received multi-level signal by using the same key information, and optimizes signal-to-noise power ratio of the multi-level signal, thereby causing cipher text obtained by an eavesdropper to foe erroneous. Accordingly, the eavesdropper needs to perform decryption processing while considering that correct cipher text is different from that obtained on a voluntary basis. Therefore, the number of attempts required for the decryption processing, that is, computational complexity, is increased compared to a case without an error, and thus safety against eavesdropping can be increased.

Further, a bit inversion is intentionally applied to some of a random number sequence, which determines a value of the multi-level signal, whereby it becomes significantly complicated for the eavesdropper to identify initial values of a random number generator which is necessary to generate the random number sequence, that is, to identify the key information. Accordingly, high secrecy can be maintained even in the case where the number of multi levels of a multi-level signal is relatively low.

### BRIEF DESCRIPTION OF THE DRAWINGS

FIG. 1 is a block diagram showing a configuration of a data communication apparatus according to a first embodiment of the present invention.

FIG. 2 is a schematic diagram showing waveforms of signals transmitted through the data communication apparatus according to the first embodiment of the present, invention.

FIG. 3 shows is a schematic diagram showing names of the waveforms of the signal transmitted through the data communication apparatus according to the first embodiment of the present invention.

FIG. 4 is a schematic diagram showing quality of the signals transmitted through the data communication apparatus according to the first embodiment of the present invention.

FIG. 5 is a block diagram showing a configuration of a data communication apparatus according to a second embodiment of the present invention.

FIG. 6 is a block diagram showing a configuration of a data communication apparatus according to a third embodiment of the present invention.

FIG. 7 is a schematic diagram showing parameters of signals transmitted through a data communication apparatus according to a fourth embodiment of the present invention.

FIG. 8 is a block diagram showing an exemplary configuration of a data communication apparatus according to a fifth embodiment of the present invention.

FIG. 9 is a block diagram showing a configuration of a first multi-level code generation section 156a.

FIG. 10 is a block diagram showing a configuration of a second multi-level code gene rat ion section 256a.

FIG. 11 is a block diagram showing, in detail, an exemplary configuration of the first multi-level code generation section 156a.

FIG. 12 is a diagram showing changes in the signals in the first multi-revel code generation section 156a.

FIG. 13 is a diagram showing waveforms of transmission signal 3 of the data communication apparatus according to the fifth embodiment of the present invention.

FIG. 14 is a block diagram showing a configuration of a possible eavesdropper receiving apparatus.

FIG. 15 is a block diagram showing, in detail, an exemplary configuration of the first multi-level code generation section 156a.

FIG. 16 is a diagram showing the signal changes in the first multi-level code generation section 156a.

FIG. 17 is a block diagram showing an exemplary configuration of the data communication apparatus in the case where an error correction code is applied.

FIG. 18 is a block diagram showing an exemplary configuration of a data communication apparatus according to a sixth embodiment of the present invention.

FIG. 19 is a block diagram showing, in detail, an exemplary configuration of a first multi-level code generation section 162a according to the sixth embodiment of the present invention.

FIG. 20 is a diagram showing signal changes in the first multi-level code generation section 162a.

FIG. 21 is a diagram showing waveforms of signals transmitted through the data communication apparatus according to a sixth embodiment of the present invention.

FIG. 22 is a block diagram showing an exemplary configuration of an LFSR.

FIG. 23 is a diagram showing exemplary outputs from the LFSR.

FIG. 24 is a diagram illustrating a maximum number of consecutive bits, which are free from an error, in eavesdropper random number series.

FIG. 25 is a block diagram showing an exemplary configuration of a data communication apparatus according to an eighth embodiment of the present, invention.

FIG. 26 is a block diagram showing an exemplary configuration of a second multi-level code generation section 260a according to the eighth embodiment of the present invention.

FIG. 27 is a diagram illustrating waveforms of signals transmitted through the data communication apparatus according to the eighth embodiment of the present invention.

FIG. 28 is a block diagram showing a configuration of a conventional data communication apparatus.

### DESCRIPTION OF THE REFERENCE CHARACTERS

10, 18 information data
11, 16 key information
12, 17 multi-level code sequence
13, 15 multi-level signal
19, 20 inverted information data
14 modulated signal
22 noise-overlapped multi-level signal
55, 56 control signal
60, 61 timing signal
84 random number signal
85, 89 selection signal
86, 88 selected bit
87 selection modulated signal
110 transmission line
111 multi-level encoding section
111a first multi-level code generation section
111b multi-level processing section
112 modulation section
113, 213 data inversion section
114 noise control section
114a noise generation section
114b combining section
132 timing signal generation section
150 first key sharing section
151 random number generation section
152 selection signal transmission line
153 amplitude control signal generation section
154 amplitude modulation section
155 control signal generation section
1501 key accumulation control section
1502 selection signal demodulation section
1503 first key accumulation section
211 demodulation section
212 multi-level decoding section
212a second multi-level code generation section
212b decision section
230 timing signal reproducing section
250 second key sharing section
255 control signal generation section
2501 key decision section
2502 selection signal modulation section
2503 second key accumulation section
10101 to 10103, 23105 to 23107 transmitting apparatus
10201 to 10202, 23205 to 23207 data receiving apparatus

### BEST MODE FOR CARRYING OUT THE INVENTION

### First Embodiment

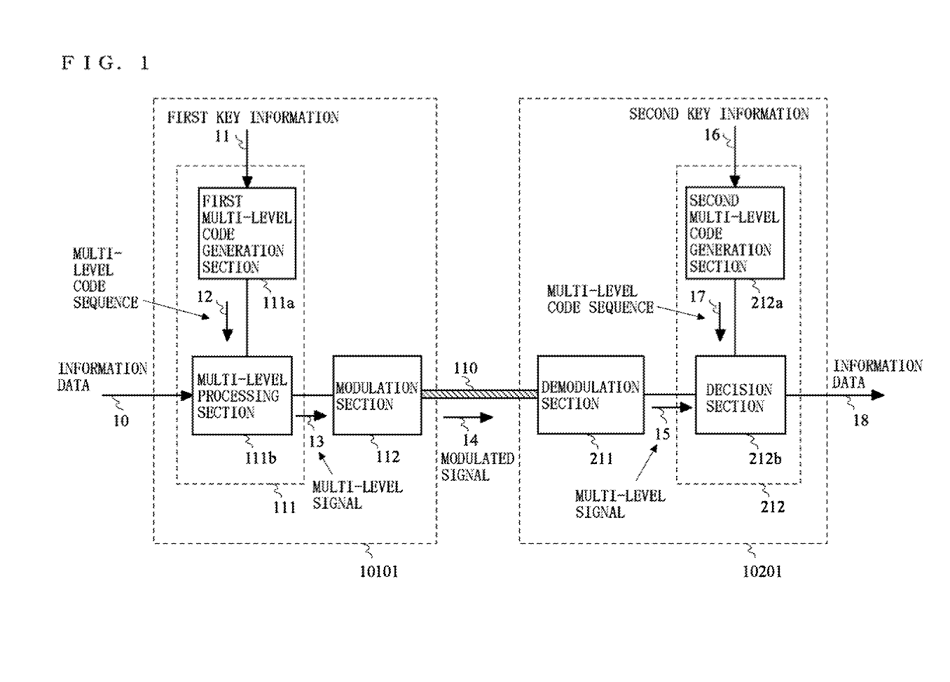

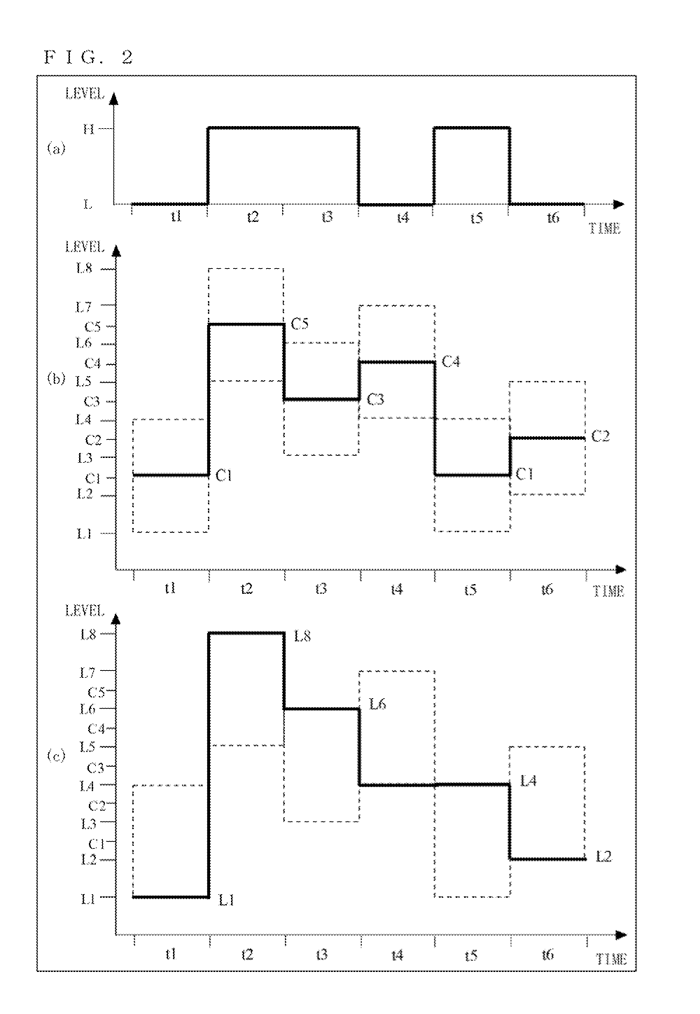

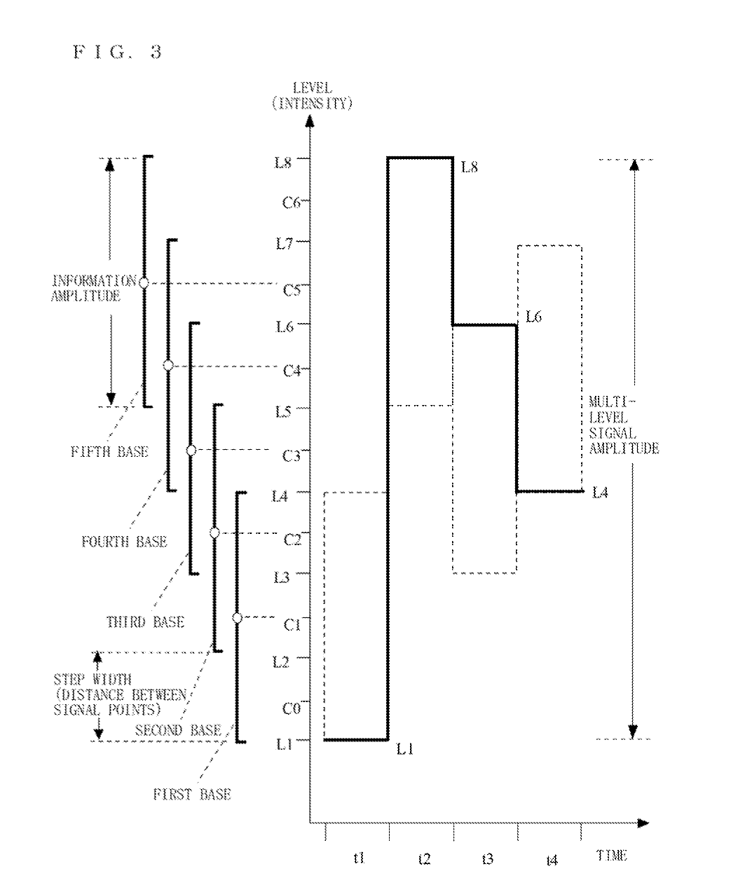

FIG. 1 is a block diagram showing a configuration of a data communication apparatus according to a first embodiment of the present invention. As shown in FIG. 1, the data communication apparatus is composed of a multi-level encoding section 111, a modulation section 112, a transmission line 110, a demodulation section 211, and a multi-level decoding section 212. The multi-level encoding section 111 is composed of a first multi-level code generation section 111a and a multi-level processing section 111b. The multi-level decoding section 212 is composed of a second multi-level code generation section 212a and a decision section 212b. Further, the multi-level encoding section 111 and modulation section 112 compose a data transmitting apparatus 10101, and the demodulation section 211 and the multi-level decoding section 212 compose a data receiving apparatus 10201. As the transmission line 110, a metal line such as a LAM cable or a coaxial line, or an optical waveguide such as an optical-fiber cable may be used. Further, as the transmission line 110, not only a wired cable suet as the LAN cable, but also free space allowing transmission of a wireless signal may be used. FIGS. 2 and 3 are each a schematic diagram showing waveforms of modulated signals outputted from the modulation section 112. Hereinafter, an operation of the data transmission apparatus will be described with reference to FIGS. 2 and 3.

The first multi-level code generation section 111a generates a multi-level code sequence 12 (FIG. 2(b)), in which a signal level changes so as to be approximately random numbers, by using predetermined first key information 11. The multi-level processing section 111b inputs thereto a multi-level code sequence 12 and information data 10 (FIG. 2(a)) so as to combine both of the signals in accordance with a predetermined procedure, and then generates and outputs a multi-level signal 13 (FIG. 2(c)) which has a level corresponding to a combination of the signal level of the multi-level code sequence 12 and that of the information data 10. For example, in FIG. 2, with respect to time slots t1/t2/t3/t4, the level of the multi-level code sequence 12 changes to c1/c5/c3/c4, and the information data 10 is added to the aforementioned level, which is used as a bias level, whereby the multi-level signal 13 which changes to L1/L8/L6/L4 is generated. Here, as shown in FIG. 3, an amplitude of the information data 10 is referred to as an “information amplitude”, a whole amplitude of the multi-level signal 13 is referred to as a “multi-level signal amplitude”, pairs of levels (L1, L4)/(L2, L5)/(L3, L6)/(L4, L7)/(L5, L8), which the multi-level signal 13 may take with respect to respective bias levels (levels of the multi-level code sequence 12) c1/c2/c3/c4/c5, are referred to as first to fifth “bases”, and a minimum distance between two signal points of the multi-level signal 13 is referred to as a “step width”. The modulation section 112 converts the multi-level signal 13, which is original data, into a modulated signal 14 in a predetermined, modulation, format, and transmits the same to the transmission line 110.

The demodulation section 211 demodulates the modulated signal 14 transmitted via the transmission line 110, and reproduces a multi-level signal 15. The second multi-level code generation section 212a previously shares second key information 16 which is identical to first key information 11, and by using the second key information 16, generates a multi-level code sequence 17 which is equivalent to the multi-level code sequence 12. The decision section 212b uses the multi-level code sequence 17 as a threshold value, performs decision (binary decision) of the multi-level signal 15, and then reproduces in formation data 18. The modulated signal 14 in the predetermined modulation format, which is transmitted between the modulation section 112 and the demodulation section 211 via the transmission line 110, is obtained by modulating an electromagnetic wave (electromagnetic field) or a light wave using the multi-level signal 13.

Regarding a method for generating the multi-level signal 13 in the multi-level processing section 111b, in addition to the above-described adding processing between the multi-level code sequence 12 and the information data 10, any method may be applicable such as a method in which the level of multi-level code sequence 12 is amplitude-modulated/controlled in accordance with the information data 10, and a method in which the level of the multi-level signal 13, which corresponds to a combination of the level of the multi-level code sequence 12 and that of the information data 10, is previously stored a memory and consecutively read from the memory in accordance with, the combination of the levels.

In FIGS. 2 and 3, the number of multi levels of the multi-level signal is described as “8”, and may be greater or lower than this, instead. The information, amplitude is described as three times or integer times of the step width of the multi-level signal, but may be any odd number times or even number times. Further, the information amplitude is not necessarily integer times of the step width of the multi-level signal. Still further, in relation to this, in FIGS. 2 and 3, the levels (bias level) of the multi-level code sequence are each located approximately at a central part between the pair of levels of the multi-level signal. However, each level of the multi-level code sequence is not necessarily located substantially at the central part between the pair of levels of the multi-level signal, or alternatively, may correspond to each level of the multi-level signal. Further the description is based on the assumption that the multi-level, code sequence and the information data are identical in a change rate to each other and also in a synchronous relation, and instead of this, the change rate of either thereof may be faster (or slower) than that of the other. Further, the multi-level code sequence and the information data may be in an asynchronous relation.

Next, eavesdropping of the modulated signal by a third party will be described. It is assumed that the third party receives and decodes the modulated signal by using a data receiving apparatus (e.g., eavesdropper data receiving apparatus) which has a configuration corresponding to the that of the data receiving apparatus 10201 held by a legitimate receiving party, or which is a further sophisticated. In the eavesdropper data receiving apparatus, the demodulation section (eavesdropper demodulation section) demodulates the modulated signal, thereby reproducing the multi-level signal. However, the multi-level decoding section (eavesdropper multi-level decoding section) does not share the first key information 11 with the data transmitting apparatus 10101, and thus, unlike the data receiving apparatus 10201, cannot per form hi nary decision of the multi-level signal by using the multi-level code sequence, which is generated based on the key information, as a reference. As a method of the eavesdropping possibly performed in such a case, a method for simultaneously performing decision of all the levels of the multi-level signal (general referred to as an “all-possible attack”) may be considered. That is, the eavesdropper performs simultaneous decision by preparing all threshold values corresponding to respective distances between signal points possibly taken by the multi-level signal, analyzes a result of the decision, and then extracts correct key information or correct information data. For example, the eavesdropper uses the levels c0/c1/c2/c3/c4/c5/c6 of the multi-level code sequence shown in FIG. 2 as the threshold values, per forms multi-level decision on the multi-level signal, and then decides the levels.

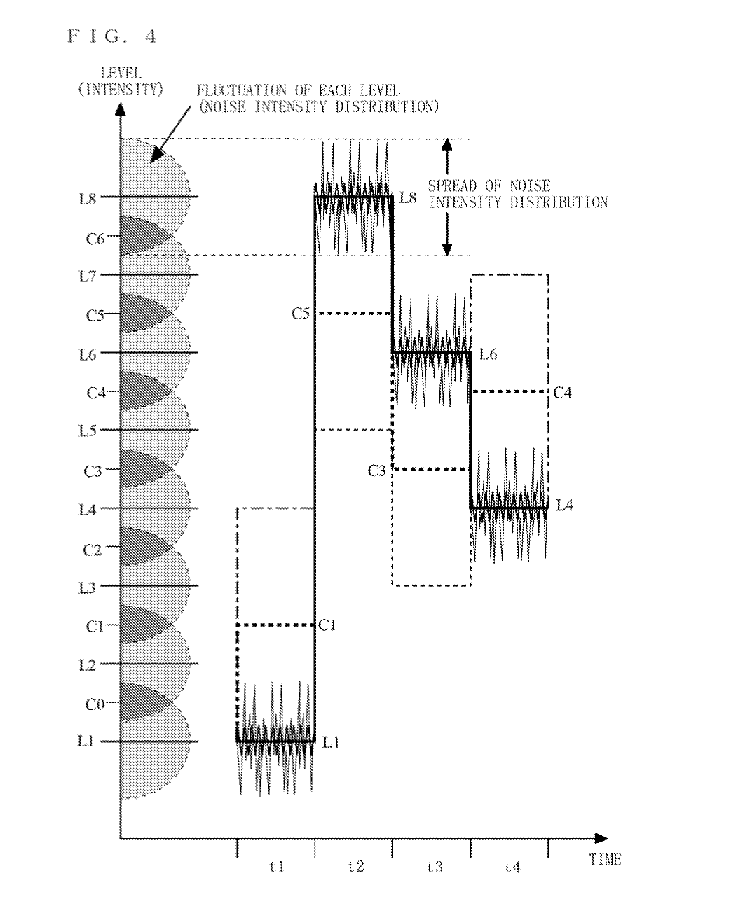

However, in an actual transmission system, a noise is generated due to various factors, and is overlapped on the modulated signal, whereby the level of the multi-level signal fluctuates temporally/instantaneously as shown in FIG. 4. In this case, an SN ratio (a signal-to-noise intensity ratio) of a signal-to-be-decided, based on binary decision by the legitimate receiving party (the data receiving apparatus 10201) is determined based on a ratio between the information amplitude of the multi-level signal and a noise level included therein. On the other hand, the SN ratio of the signal-to-be-decided based on the multi-level decision by the eavesdropper data receiving apparatus is determined based on a ratio between the step width of the multi-level signal and the noise level included therein. Therefore, in the case where a condition of the noise level included in the signal-to-be-decided is fixed, the SN ratio of the signal-to-be decided by the eavesdropper data receiving apparatus becomes relatively small, and thus a transmission feature (an error rate) deteriorates. That is, it is possible to induce a decision error in the all-possible attacks performed by the third party using all the thresholds, and to cause the eavesdropping to become difficult. Particularly, in the case where the step width of the multi-level signal 15 is set at an order equal to or less than a noise amplitude (spread of a noise intensity distribution), the multi-level decision by the third party is substantially disabled, and a preferable eavesdropping prevention can be realized.

As the noise overlapped on the signal-to-be-decided (the (multi-level signal or the modulated signal) as above described, a thermal noise (Gaussian noise) included in a space field or an electronic device, etc. may foe used, when an electromagnetic wave such as a wireless signal is used as the modulated signal, whereas a photon number fluctuation (quantum noise) at the time when the photon is generated may be used in addition to the thermal noise, when the optical wave is used. Particularly, signal processing such as recording and replication is not applicable to a signal using the quantum noise, and thus the step width of the multi-level signal is set by using the level of the noise as a reference, whereby the eavesdropping by the third party is disabled and an absolute security of the data communication is ensured.

As above described, according to the present embodiment, the information data to be transmitted is encoded as the multi-level signal, and the distance between the signal points is set appropriately with respect to the noise level, whereby quality of the receiving signal at the time of the eavesdropping by the third party is crucially deteriorated. Accordingly, it is possible to provide a further safe data communication apparatus which causes decryption/decoding of the multi-level signal by the third party to become difficult.

### Second Embodiment

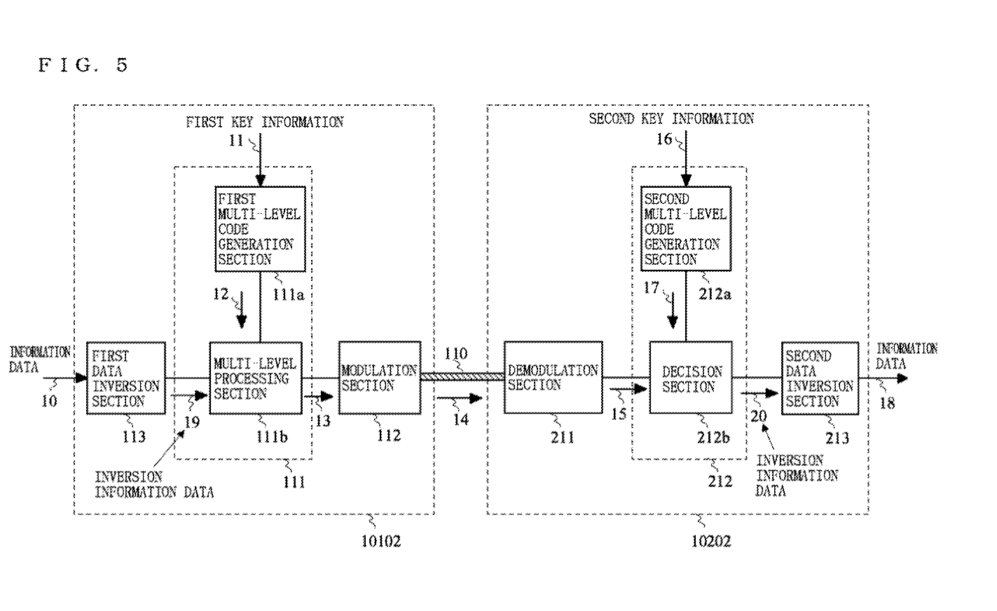

FIG. 5 is a block diagram showing a configuration of a data communication apparatus according to a second, embodiment of the present invention. As shown in the diagram, the data communication apparatus includes the multi-level encoding section 111, the modulation section 112, the transmission line 110, the demodulation section 211, the multi-level decoding section 212, a first data inversion section 113, and a second data inversion section 213, and is different from the configuration shown in FIG. 1 in that the first data inversion section 113 and the second data inversion section 213 are provided thereto. A data transmitting apparatus 10102 is composed of the multi-level encoding section 111, the modulation section 112, and the first data inversion section 113, whereas a data receiving apparatus 10202 is composed of the demodulation section 211, the multi-level decoding section 212, and the second data, inversion section 213. Hereinafter, an operation of the data communication apparatus according to the present embodiment will be described.

Since the configuration of the present embodiment corresponds to that of the first embodiment (FIG. 1), those functional blocks which perform common operations are provided with common reference characters, and descriptions thereof will be omitted. Only different points will be described. In the configuration, the first data inversion section 113 does not fix a correspondence relation between information composed, of “0” and “1” contained in the information data and levels composed of a Low level and a High level, and instead, changes the correspondence relation approximately randomly in accordance with a predetermined procedure, for example, in the same manner as the multi-level encoding section 111, an Exclusive OR (XOR) operation between the information data and a random number series (pseudo random number sequence), which is generated based on a predetermined initial value, is performed, and a result of the operation is outputted to the multi-level encoding section 111. In a manner reverse to that performed by the first data inversion section 113, the second data inversion section 213 changes the correspondence relation between the information composed of “0” and “1” contained in data outputted from the multi-level decoding section 212 and the levels composed, of the Low level and the High level. For example, the second data inversion section 213 shares an initial value with the first data inversion section 113, which the initial value is identical to an initial value included in the first data inversion section 113, performs the XOR operation between a bit inverted random number series, the random number series being generated based on the initial, value and the data outputted from, the multi-level encoding section 212, and then outputs the resultant as the information data.

As above described, according to the present embodiment, information data to be transmitted is inverted approximately randomly, whereby complexity of the multi-level signal as a secret code is increased. Accordingly, decryption/decoding by a third party is caused to become further difficult, and a further safe data communication apparatus may be provided.

### Third Embodiment

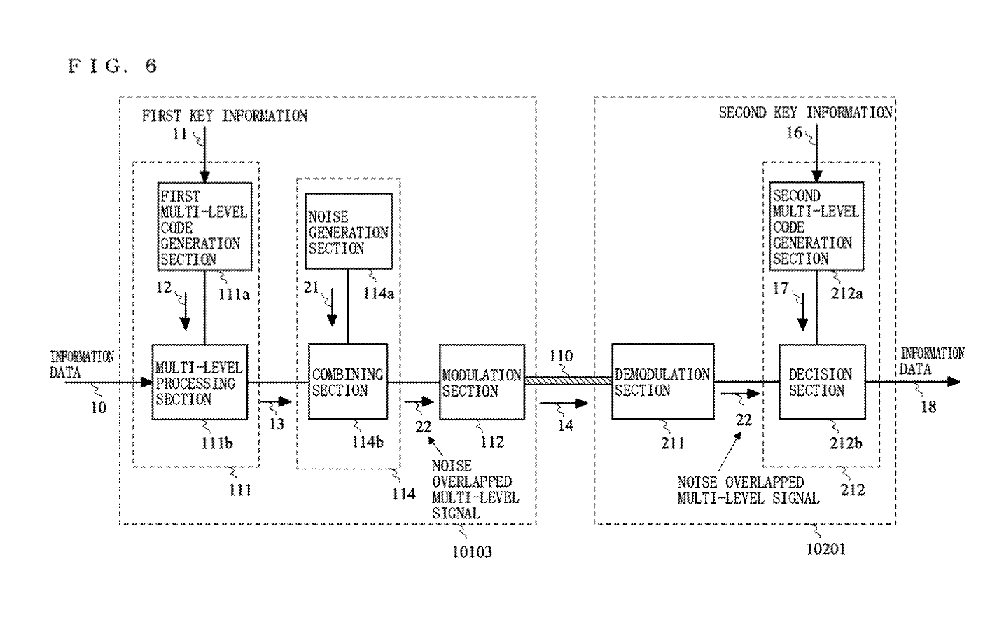

FIG. 6 is a block diagram showing a configuration of a data communication apparatus according to a third embodiment of the present invention. As shown in FIG. 6, the data communication apparatus includes the multi-level encoding section 111, the modulation section 112, the transmission line 110, the demodulation section 211, the multi-level decoding section 212, and a noise control section 114, and is different from the configuration shown in FIG. 6 in that the noise control section 114 is additionally included. Further, the noise control section 114 is composed of a noise generation section 114a and a combining section 114b. A data transmitting apparatus 10103 is composed of the multi-level encoding section 111, the modulation section 112, and the noise control section 114, whereas the data receiving apparatus 10201 is composed of the demodulation section 211 and the multi-level decoding section 212. Hereinafter, an operation of the data transmitting apparatus will be described.

Since the configuration of the present embodiment corresponds to that of the first embodiment (FIG. 1), those functional blocks which perform operations identical to that of the first embodiment are provided with common reference characters, and descriptions thereof will be omitted. Only different points will be described. In the noise control section 114, the noise generation section 114a generates a predetermined noise. The combining section 114b combines the predetermined noise and the multi-level signal 13, and outputs the combined signal to the modulation section 112. That is, the noise control section 114 purposely cause a level fluctuation in the multi-level signal illustrated in FIG. 4, controls the SN ratio of the multi-level signal so as to be an arbitrary value, and then controls the SN ratio of a signal-to-be-decided which is inputted to the decision section 212b. As above described, as the noise generated in the noise generation section 114a, the thermal noise, quantum noise or the like is used. Further, the multi-level signal on which the noise is combined (overlapped) will be referred to as a noise-overlapped multi-level signal 22.

As above described, according to the present embodiment, information data to be transmitted is encoded as the multi-level signal, and the SN ratio thereof is controlled arbitrarily, whereby quality of a received signal at the time of eavesdropping by a third party is deteriorated crucially. Accordingly, it is possible to provide a further safe data communication apparatus which causes decryption/decoding of the multi-level signal by the third party to become difficult.

### Fourth Embodiment

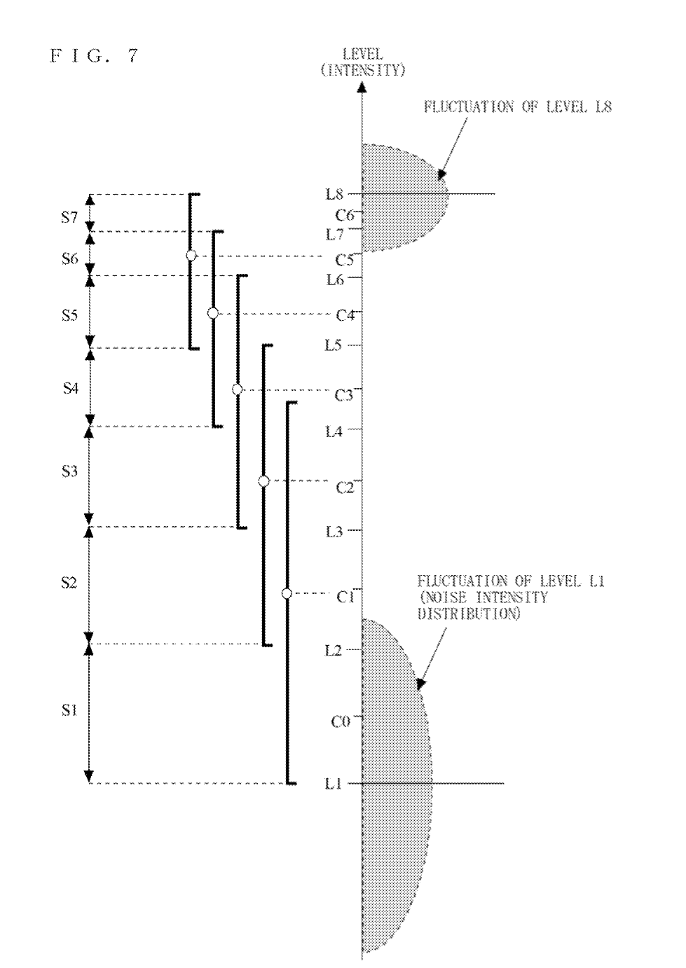

An operation of a data communication apparatus according to a fourth embodiment of the present invention will be described. Since a configuration of the present embodiment corresponds to that of the first embodiment (FIG. 1) or the third embodiment (FIG. 6), a block diagram thereof will be omitted. In the fourth embodiment, as shown in FIG. 7, the multi-level encoding section 111 sets respective step widths (S1 to S7) between the respective levels of the multi-level signal in accordance with fluctuation ranges of the respective levels, i.e., noise intensity distributions overlapped on the respective levels. Specifically, distances between adjoining two signals points are allocated such that the respective SN ratios are substantially equal to one another, each of the SN ratios being determined between the adjoining two signal points of a signal-to-be-decided which is inputted to the decision section 212b. When noise levels to foe overlapped on the respective levels of the multi-level signal are equal to one another, the respective step widths are allocated uniformly.

Generally, in the case where an optical intensity modulated signal whose light source is a laser diode (LD) is assumed as a modulated signal outputted from the modulation section 112, the fluctuation range (noise level) varies depending on the levels of the multi-level signal to be inputted to the LD. This results from the fact that the LD emits light based on the principle of stimulated emission which uses a spontaneous emission light as a “master light”, and the noise level is defined based on a relative ratio between a stimulated emission light level and a spontaneous emission light level. The higher an excitation rate (corresponding to a bias current injected to the 133) is, the larger a ratio of the stimulated emission light level becomes, and consequently the noise level becomes small. On the other hand, the lower the excitation rate of the LD is, the larger a ratio of the natural emission light level becomes, and consequently the noise level becomes large. Accordingly, as shown in FIG. 7, in an area in which the level of the multi-level signal is small, the step width is set to be large in a non-linear manner, whereas in an area in which the level thereof is large, the step width is set to be small in a non-linear manner, whereby the SN ratios between the respective adjoining two signal points of the signal-to-be-decided can be made equal to one another.

In the case where a light modulated signal is used as the modulated signal, under the condition where the noise caused by the natural emission light and a thermal noise used for an optical receiving apparatus are sufficiently small, the SN ratio of the received signal is determined mainly based on a shot noise. Under such a condition, the greater the level of the multi-level signal is, the greater the noise level becomes. Accordingly, Unlike the case shown in FIG. 7, in the area where the level of the multi-level signal is small, the step width is set to be small, whereas in the area where the level of the multi-level signal is large, the step width is set to be large, whereby each of the SN ratios between the respective adjoining two signal levels of the signal-to-be-decided can be made equal to one another.

As above described, according to the present embodiment, the information data to be transmitted is encoded as the multi-level signal, and the distances between the respective signal points of the multi-level signal are allocated substantially uniformly. Alternatively, the SN ratios between the respective adjoining signal points are set substantially uniformly regardless of instantaneous levels. Accordingly, the quality of the receiving signal at the time of eavesdropping by a third party is crucially deteriorated all the time, and it is possible to provide a further safe data communication apparatus which causes decryption/decoding of the multi-level signal by the third party to become difficult.

### Fifth Embodiment

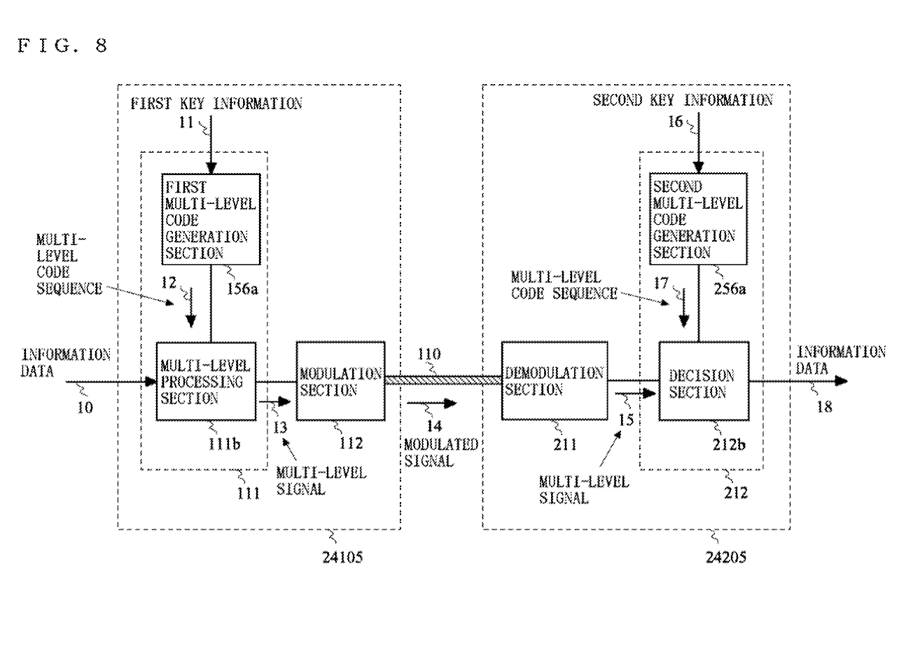

FIG. 8 is a block diagram showing a configuration of a data communication apparatus according to a fifth embodiment of the present invention. As shown in FIG. 8, the data communication apparatus has a configuration in which a data transmitting apparatus 24105 and a data receiving apparatus 24205 a connected to each other via a transmission line 110. The data transmitting apparatus 24105 includes the multi-level encoding section 111 and the modulation section 112. The data receiving apparatus 24205 includes the demodulation section 211 and the multi-level decoding section 212. The multi-level encoding section 111 includes a first multi-level code generation section 156a and the multi-level processing section 111b. The multi-level decoding section 212 includes a second multi-level code generation section 256a and the decision section 212b.

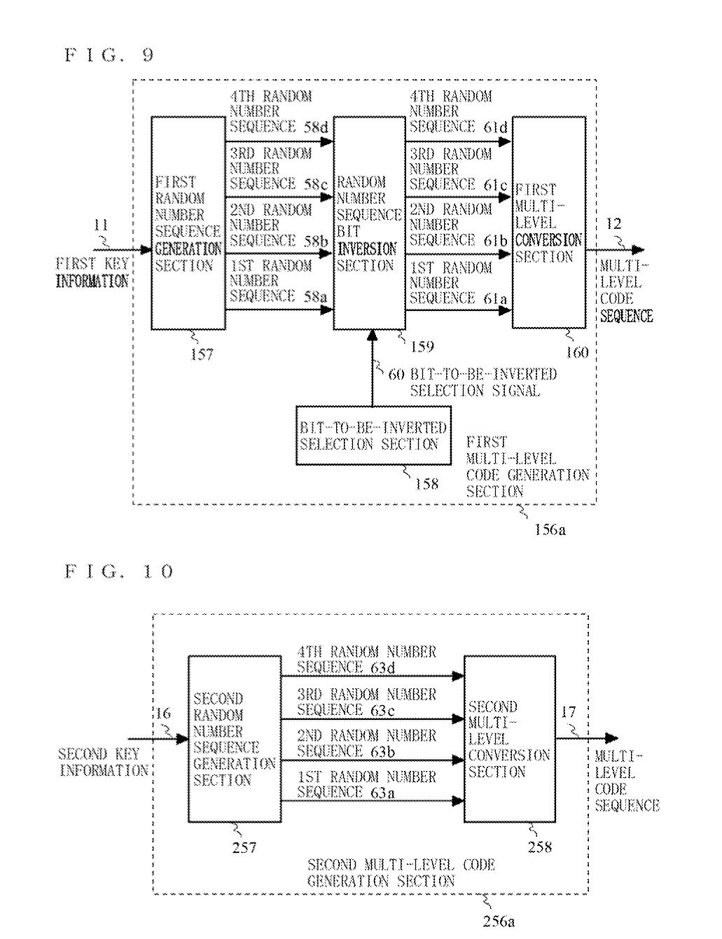

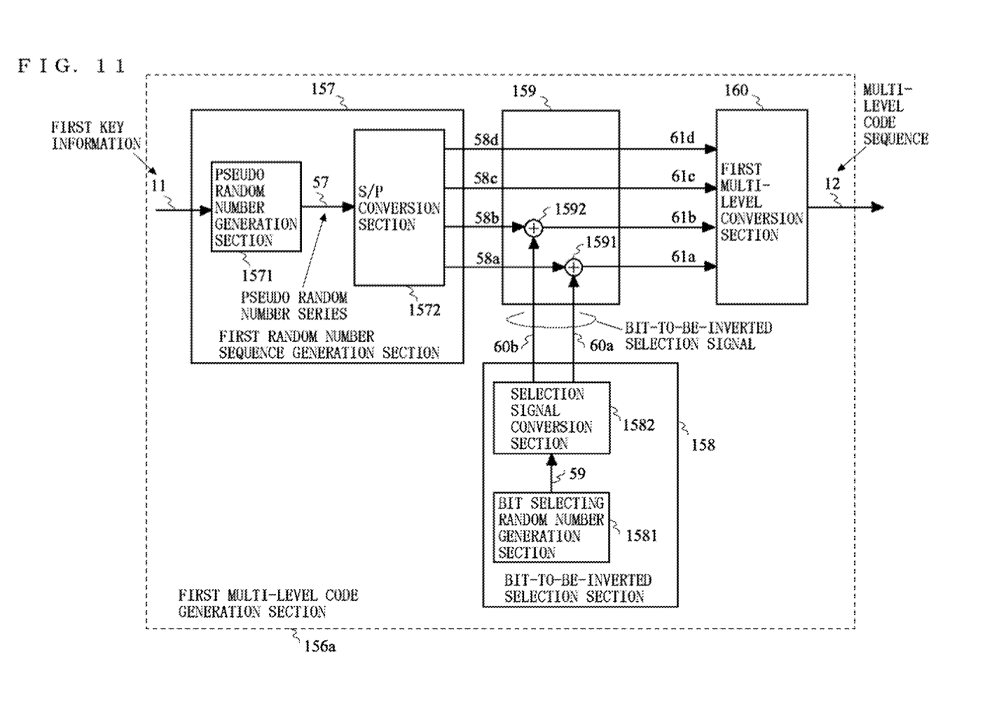

FIG. 9 is a block diagram showing a configuration of the first multi-level code generation section 156a. As shown in FIG. 9, the first multi-level code generation section 156a includes a first random number sequence generation section 157, a bit-to-be-inverted selection section 158, a random number sequence bit inversion section 159, and a first multi-level conversion section 160. FIG. 9 is exemplified by a case where the number of bits of the multi-level code sequence 12 generated by the first multi-level code generation section 156a is 4 bits. FIG. 10 is a block diagram showing a configuration of the second multi-level code generation section 256a. As shown in FIG. 10, the second multi-level, code generation section 256a includes a second random number sequence generation section 257 and a second multi-level conversion section 258.

For example, in the data communication apparatus according to the first embodiment, when the step width, which is the minimum distance between two signal levels of the multi-level signal 13, is greater than a level of a quantum fluctuation, a sufficient error may not occur at the time of the multi-level decision. In this case, in a certain time slot, eavesdropper may possibly identify a level which is identical to an original level of the multi-level signal without mistake. In this situation, there is no error included in a part corresponding to the time slot, among the random number series obtained through the multi-level decision by the eavesdropper, and thus decryption of the key information may be possible. The present embodiment aims to address such a situation.

First, an operation of the data communication apparatus according to the present embodiment will be described. The first random number sequence generation section 157 generates first to fourth random number sequences 58a, 58b, 58c, and 58d by using the first key information 11. The bit-to-be-inverted selection section 158 outputs a bit-to-be-inverted selection signal 60 in accordance with a predetermined rule. The predetermined rule may be any rule as long as the rule cannot be assumed by the eavesdropper easily. Preferably, the rule is determine a based on random numbers. The random number sequence bit inversion section 159 selects one or more of the first to fourth random number sequences 58a, 58b, 58c, and 58d in accordance with the bit-to-be-inverted selection signal 60, inverts a bit of the selected random number sequences, and then outputs the first to fourth random number sequences 61a, 61b, 61c, and 61d. The first multi-level conversion section 160 converts the first to fourth random number sequences 61a, 61b, 61c, and 61d into the multi-level code sequence 12. As the first multi-level conversion section 160, a D/A converter may foe used, specifically.

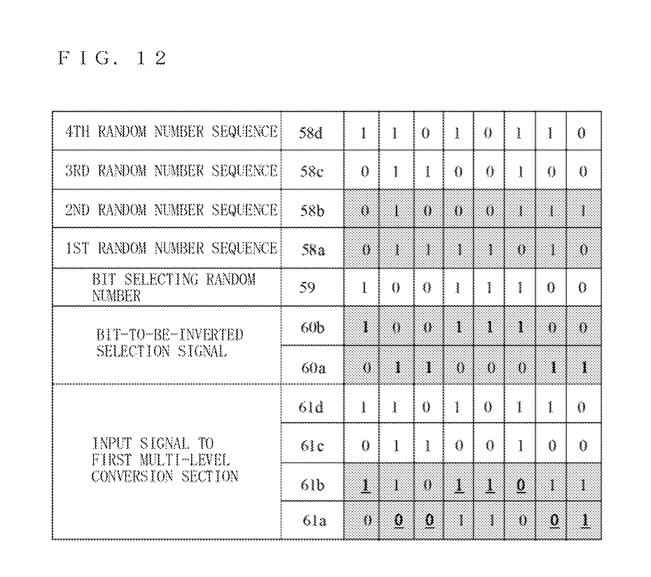

FIG. 11 is a block diagram showing, in detail, an exemplary configuration of the first multi-level code generation section 156a. As shown in FIG. 11, the first random number sequence generation section 157 includes a pseudo random number generation section 1571 and an SAP conversion section 1572. The pseudo random number generation section 1571 generates pseudo random number series 57 by using the first key information 11. The S/P conversion section 1572 performs serial/parallel (S/P) conversion on the pseudo random number series 57, and then outputs first to fourth random number sequences 58a, 58b, 58c, and 58d.

The bit-to-be-inverted selection section 158 includes a bit-selecting random number generation section 1581 and a selection signal conversion section 1582. The bit-selecting random number generation section 144 generates a bit-selecting random number 58. The selection signal conversion section 1582 converts values of the bit-to-be-inverted selection signals 58a and 58b in accordance with the bit-selecting random number 59. The bit-selecting random number generation section 1581 preferably generates genuine random numbers based on physical phenomena, instead of artificial pseudo random numbers. The random number sequence bit inversion section 159 includes XOR circuits 1591 and 1592.

To the XOR circuit 1591, the first random number sequence 58a and the bit-to-foe-inverted selection signal 60a are inputted. The XOR circuit 1591 outputs the inputted first random number sequence 58a in situ without performing a bit inversion thereof when the bit-to-be-inverted selection signal 60a is “0”, whereas outputs the first random number sequence 58a by performing the bit inversion thereof when the bit-to-be-inverted selection signal 60a is “1”. To the XOR circuit 1592, the second random number sequence 58b and a bit-to-be-inverted selection signal 60b are inputted. The XOR circuit 1592 performs the same operation as the XOR circuit 1591. Note that at least one of the bit-to-be-inverted selection signals 60a and 60b has a value “1”.

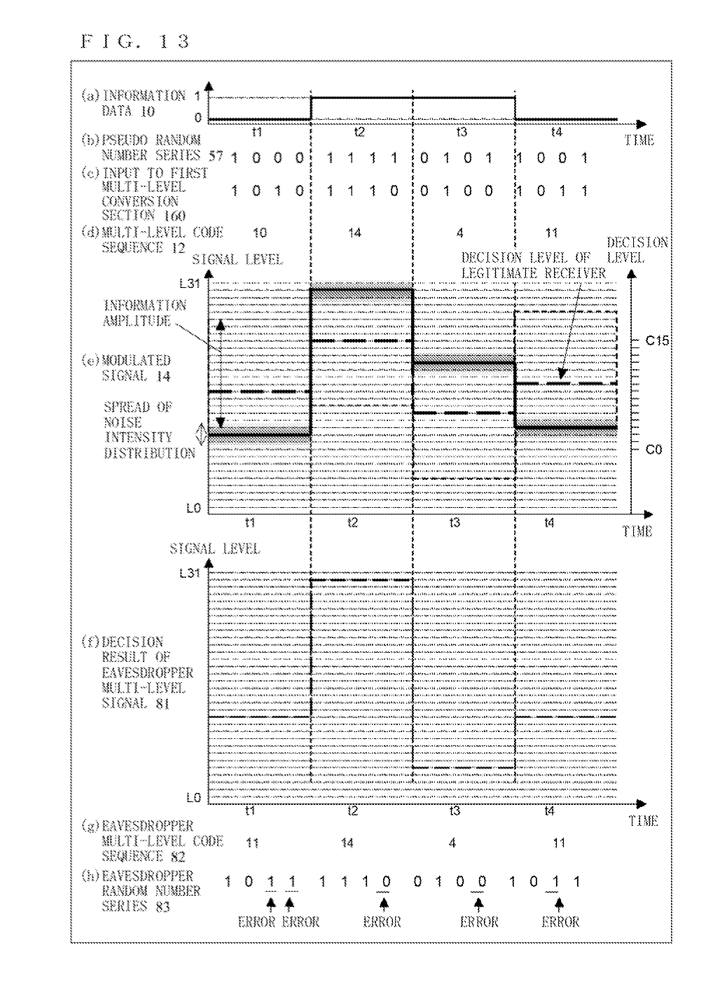

Here, an operation of the first multi-level code generation section 156a will foe described in detail with reference to FIG. 12 on the premise of the exemplary configuration shown in FIG. 11. FIG. 12 is a diagram showing changes in the signals in the first multi-level code generation section 156a. First, suppose that the first to fourth random number sequences 58a, 58b, 58c, and 58d outputted from the first random number sequence generation section 157 and the bit-selecting random number 59 outputted from the bit-selecting random number generation section 1581 respectively take values as shown in FIG. 12. The selection signal conversion section 1582 sets a value “1” to the bit-to-toe-inverted selection signal 60a, and sets a value “0” to the bit-to-be-inverted selection signal 60b when the value of the bit-selecting random number 59 is “0”. Further, the selection signal conversion section 1582 sets a value “0” to the bit-to-be-inverted, selection signal 60a and a vale “1” to the bit-to-be-inverted selection signal 60b, when the value of the bit-selecting random number 59 is “1”.

The random number sequence bit inversion section 159 performs the bit inversion on and then outputs the first random number sequence 58a when the value of the bit-to-be-inverted selection signal 60a is “1”, whereas outputs the first random number sequence 58a in situ when the bit-to-be-inverted selection signal 60a is “0”. Further, the random number sequence bit layers ion section 159 performs the bit inversion on and then outputs the second random number sequence 58b when the bit-to-be-inverted selection signal 60b is “1”, whereas outputs the second random number sequence 58b in situ when the bit-to-be-inverted selection signal 60b is “0”. In this case, the values of the bit-to-be-inverted selection signals 60a and 60b, and the values of the first to fourth random number sequences 61a, 61b, 61c, and 61d to be inputted to the first multi-level conversion section 160 are as shown in FIG. 12. That is, regarding the values of bits of the first to fourth random number sequences 61a, 62b, 62c and 61d, at least one of the bits thereof is inverted compared to the values of the bits of the first to fourth random number sequences 50a, 58b, 58c, and 53d.

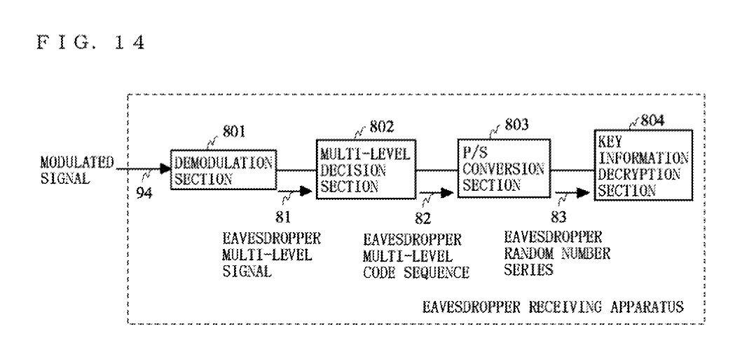

Next, a method of generating the multi-level signal 13 and the modulated signal 14 by using the first to fourth random number sequences 61a, 61b, 61c, and 61d will be described. FIG. 13 is at diagram showing waveforms of signals transmitted through the data communication apparatus according to the fifth embodiment of the present invention. Suppose that the information data 11 takes values as shown in FIG. 13(a). When the pseudo random number series 57 outputted from the pseudo random number generation, section 1571 takes values as shown in FIG. 13(b), values of the multi-level code sequence 12 are those as shown in FIG. 13(d) in accordance with the procedure described with reference to FIG. 12.

The multi-level processing section 111b inputs thereto the multi-level code sequence 12 and the information data 10, combines both of the signal levels in accordance with, a predetermined procedure, and then generates the multi-level signal 13 having the level corresponding to the combination of both of the signal levels. In an example shown in FIG. 13, the multi-level, processing section 111b multiplies respective values “0, 1, 1, 0” of the information data 10 by 16 times, adds thereto values “10, 14, 4, 11” of the multi-level code sequence 12, respectively, and outputs the resultant as the multi-level signal 13. The modulation section 112 converts the multi-level signal 13, which is the original data, into the modulated signal 14 in a predetermined modulation format, which is then outputted to the transmission line 110.

The demodulation section 211 demodulates the modulated signal 14 transmitted via the transmission line 110, and reproduces a multi-level signal 15. In the second multi-level code generation section 256a (see FIG. 10), the second random number sequence generation section 257 previously has the second key information 16 which is identical to the first key information 11, in a shared manner, and generates, by using the second key information 16, the first to fourth random number sequences 63a, 63b, 63c and 63d, which are equivalent to the first to fourth random number sequences 58a, 58b, 58c and 58d, respectively. The second multi-level conversion section 258 converts the first to fourth random number sequences 63a, 63b, 63c and 63d into the multi-level code sequence 17 so as to be outputted to the decision section 212b. The decision section 212b uses values corresponding to the multi-level code sequence 17 as decision levels (as shown as dotted lines in FIG. 13(e)), performs decision (binary decision) of the multi-level signal 15, and then reproduce information data 18.

Next, eavesdropping of the modulated signal 14 by a third party will be described. FIG. 14 is a block diagram showing a configuration of a possible eavesdropper receiving apparatus. Suppose that the eavesdropper simultaneously performs decision of all the levels of the multi-level signal, by using the receiving apparatus shown in FIG. 14, so as to attempt to extract key information. As shown in FIG. 14, a demodulation section 301 demodulates a modulated signal 34, and outputs the resultant as an eavesdropper multi-level signal 81. Next, the decision section 802 performs the multi-level decision of the eavesdropper multi-level signal 81 so as to Identify bases used for the eavesdropper multi-level signal 81, and outputs values of the multi-level code sequence, which correspond, to the obtained bases, as an eavesdropper multi-level code sequence 82. An S/P conversion section 803 performs S/P conversion of the eavesdropper multi-level code sequence 82, and outputs the resultant as the eavesdropper random number series S3. A key information decryption section 304 attempts to decrypt the key information from the eavesdropper random number series 83 by using mathematical processing.

In this case, the multi-level decision of the eavesdropper multi-level signal 81 by the eavesdropper results in containing an error, which is caused, by a noise (quantum fluctuation), as compared to the original multi-level signal levels as shown in FIG. 13(f). The eavesdropper random number series 82 (represented in decimal form), which is obtained as a result of the decision, is shown in FIG. 13(g). When the eavesdropper random number series 83 (see FIG. 13(h)) is reproduced based, on this, the resultant contains an error caused by the bit inversion performed in the random number sequence bit inversion sections 1591 and 1592 in addition to that caused by the noise (quantum fluctuation), as compared to the original pseudo random number series 57. Since the eavesdropper does not have information relating a method for selecting a bit-to-be-inverted, the eavesdropper cannot correct the error caused by the bit inversion. Further, when a bit to be inverted is selected from the genuine random number, the eavesdropper cannot specify the bit at all. Since the multi-level code sequence 12 inevitably contain a bit which has been inverted, the error caused by the bit inversion occurs inevitably once per time slot. Therefore, even in the case where the error caused by the quantum fluctuation occurs insufficiently, it is possible to cause the eavesdropper to generate an error, which is sufficient enough to make the decryption of the key information impossible.

Accordingly, the data communication apparatus according to the present embodiment is able to set a step width larger than the quantum fluctuation, and consequently requirements on the number of multi levels and an operation speed of the pseudo random number generation section may be eased.

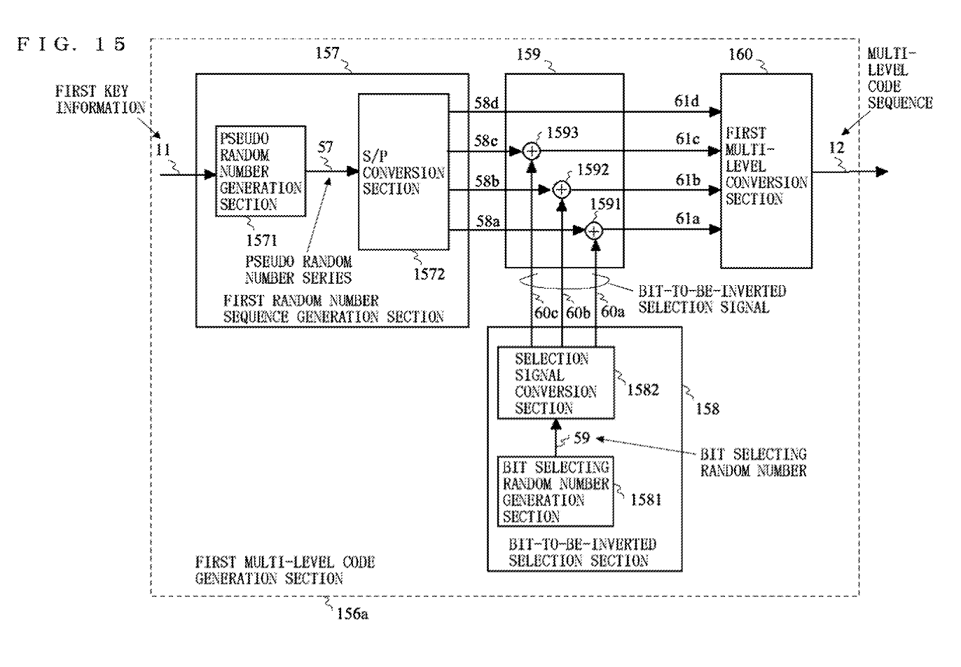

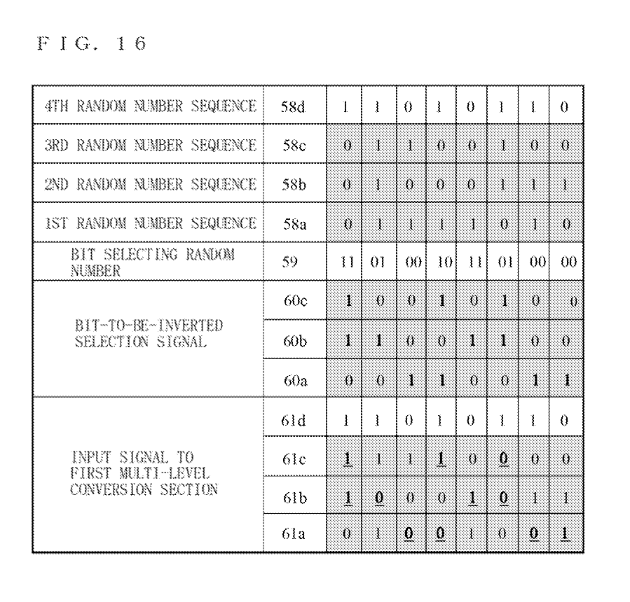

In the above description is exemplified by a case where the bit inversion is performed with respect to 1 bit of the multi-level code sequence 12, however, the number of the bits to be inverted is not only one, but a plurality of bits may be inverted. For example, a specific exemplary configuration of the first multi-level code generation section 156a in the case where 2 bits are to be inverted is shown in FIG. 15, and exemplary values taken by signals in respective sections are shown in FIG. 16, respectively. As shown in FIG. 15, the random number sequence bit inversion section 153 has three XOR circuits 1591 to 1593, selects one or two of the third random number sequences 58a, 58b and 58c, and perform the bit inversion of a selected random number sequence. That is, to the selection signal conversion section 1582, 2-bit bit-selecting random number 59 is inputted. The selection signal conversion section 1582 performs the inversion of the third random number sequence 58c when the first bit of the bit-selecting random number 59 is “1”, performs the bit inversion of the second random number sequence 58b when the second bit of the bit-selecting random number 59 is “1”, and per forms the bit inversion of the first random number sequence 58a when the second bit of the bit-selecting random number 59 is “0”.

The configuration of the above-described first random number sequence generation section 157, the bit-to-be-inverted selection section 158 and the random number sequence bit inversion section 159, and a method, of the bit inversion are merely examples. As long as a condition that one or more bits in the random number sequence should be inevitably inverted is satisfied, the method for generating the random number sequence, the number of the random number sequences to be inverted, and the correspondence relation, between the values of the bit-selecting random number 59 and bits to be inverted may be determined in any way. Further, the number of bits of each of the random number sequence 57 and the multi-level code sequence 12 is not limited to 4 bits, but may be set arbitrarily.

A difference between the multi-level code sequence 12 used in the data transmitting apparatus 24105 and the multi-level code sequence 17 used in the data receiving apparatus 24205, which has an effect as a deterioration in the signal level at the time of decision, that is, deterioration in the SN ratio, is set such that the deteriorated SN ratio satisfies a required value of the data receiving apparatus 24205. Therefore, a condition needs to be satisfied that, ratio between the information amplitude and a fluctuation range of the multi-level signal, which is equivalent to the random number sequence subject to the bit inversion, is greater than the SN ratio permissible by the legitimate receiving party. The SN ratio permissible by the legitimate receiving party is determined based on a bit error rate of data required by the legitimate receiving party. For example, in optical communication, a value equal to or lower than 10⁻¹² is generally used as an acceptable bit error rate, and in this case, acceptable SN ratio is equal to or more than 23 dB.

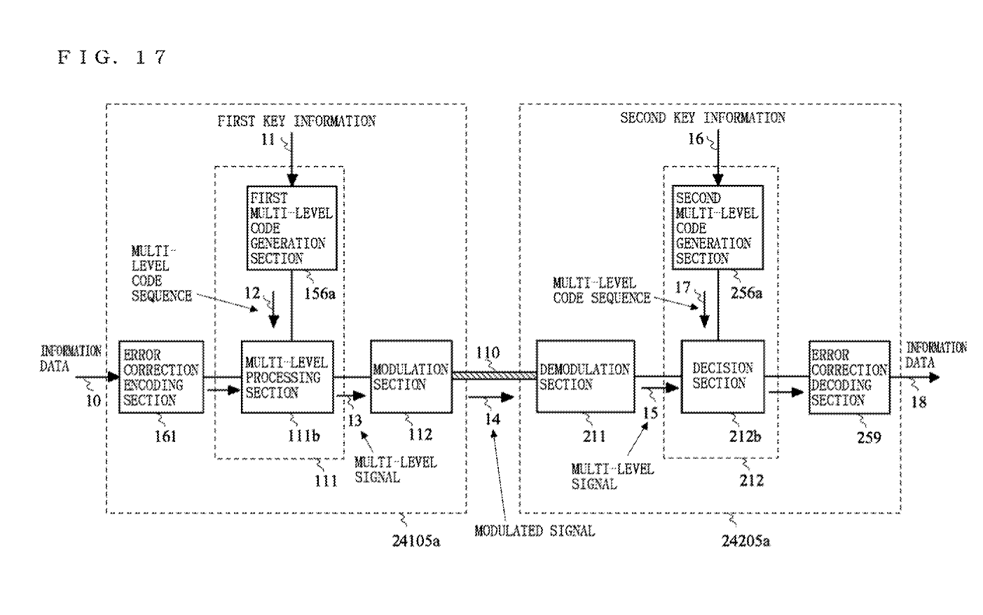

As another method, there is a method in which an error correcting code is applied to the information data so as to suppress the effect of the bit inversion on the legitimate receiving party. In this case, regarding the configuration of the data communication apparatus, as shown in FIG. 17, a transmitting apparatus 250105a includes an error correction encoding section 161, and a data receiving apparatus 24205 includes an error correction decoding section 259. The error correction encoding section 161 performs error correction encoding on the information data 10 so as to add a parity bit thereto, and outputs the resultant to the multi-level processing section 111b. The error correction decoding section 259 performs error correction processing on the information data outputted from the decision section 212b by using the parity bit having been added thereto in the error correction encoding section 161. Accordingly, even if an error is caused during the binary decision in the decision section 212b by the effect of the bit inversion performed with respect to the random number sequences 58a, 58b, 58c and 58d, the data communication apparatus can correct the error. In the case where the error correcting code is applied, there is no limitation on the ratio between the information amplitude and the fluctuation range of the multi-level signal which is equivalent to the random number sequence subject to the bit inversion, and all the random, number sequences can foe selected as to be subject to the bit inversion.

As above described, according to the present embodiment, even in the case where the magnitude of the quantum fluctuation is insufficient, it is possible to prevent decryption of the key information by the eavesdropper. Therefore, requirements on performance of the transmitting/receiving apparatus, the number of multi levels, and the operation speed of the pseudo random number generation section may be eased.

### Sixth Embodiment

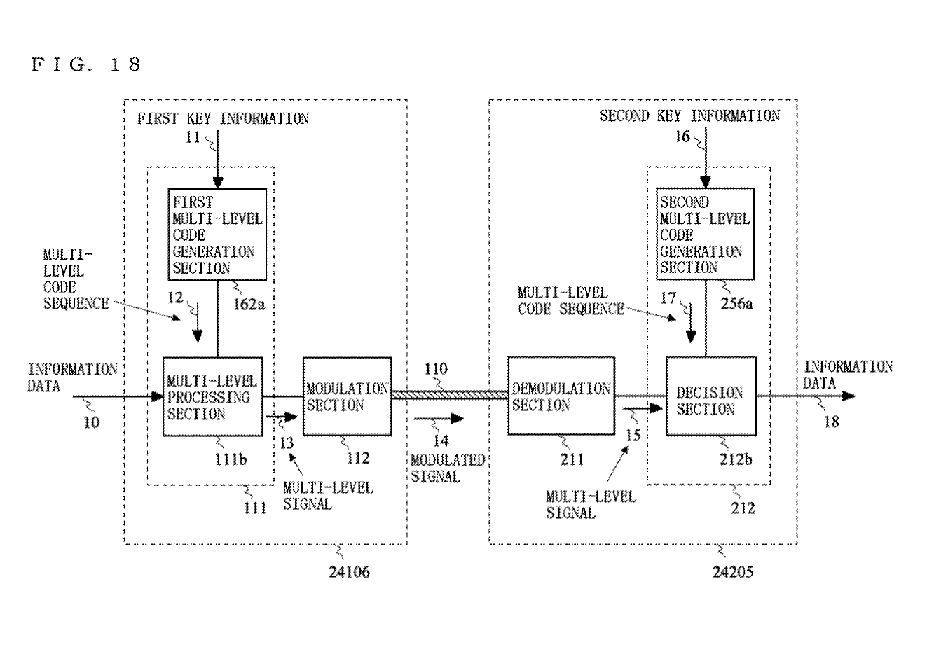

FIG. 18 is a block diagram showing an exemplary configuration of a data communication apparatus according to a sixth embodiment of the present invention. As shown in FIG. 18, an overall configuration of the data communication apparatus according to the sixth embodiment of the present invention is different from that of the fifth embodiment (FIG. 8) only in a configuration of the first multi-level code generation section 162a. A configuration of the second multi-level code generation section 256a is the same as than described with reference to FIG. 10. Hereinafter, the difference between the present embodiment and the fifth embodiment will be mainly described. Description of such functional blocks that perform the same operations as those of the fifth embodiment will be omitted.

In the case of optical transmission, the magnitude of the quantum fluctuation depends on a receiving level (receiving optical power) of an eavesdropper. That is, the lesser the receiving level is, the higher the possibility of an error occurrence in the eavesdropper multi-level code sequence 82 becomes, the err or being caused by the quantum fluctuation. The error caused by the quantum fluctuation is mainly generated in a lowest-order-bit of the eavesdropper multi-level code sequence 82. When a value of the lowest-order bit of the multi-level code sequence 12 is inverted at a transmission end, the inversion is offset by the error caused by the quantum fluctuation, and consequently the value may be returned to a correct value. That is, in the case where the possibility of the error occurrence caused by the quantum fluctuation is relatively high, a possibility of an error occurrence in the eavesdropper random number series 83 is decreased, as a result of the offset by the bit inversion at the transmission end, and consequently security level is likely to be deteriorated. The present embodiment addresses such a case.

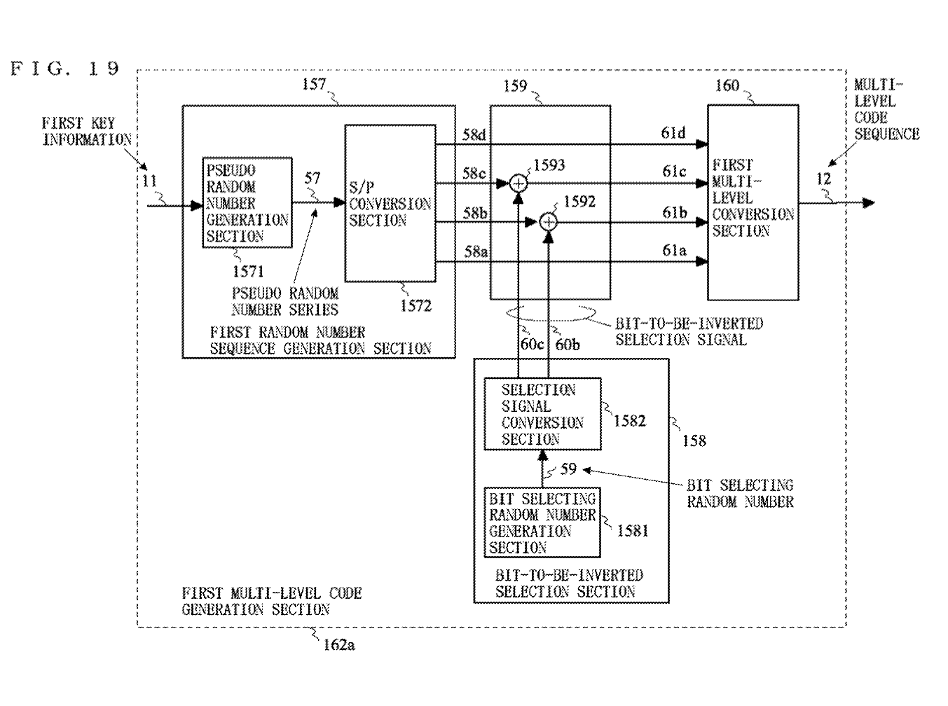

FIG. 19 is a block diagram showing, in detail, an exemplary configuration of the first multi-level code generation section 162a according to the sixth embodiment of the present invention. With reference to FIG. 19, component parts of the first multi-level code generation section 162a and operations thereof are basically the same as those described in the fifth embodiment (FIG. 11), but are different from the fifth embodiment in that second and third random number sequences 58b and 53c are selected as to be subject to the bit inversion. That is, the first multi-level code generation section 162a is different from, the first multi-level code generation section 156a (FIG. 11) according to the fifth embodiment in that the first multi-level code generation section 162a does not perform the bit inversion on the first random number sequence 58a, which is the lowest-order bit of the multi-level code sequence 12.

In FIG. 19, the second random number sequence 58b and the bit-to-be-inverted selection signal 60b are inputted to the XOR circuit 1592, and the third random number sequence 58c and the bit-to-be-inverted selection signal 60c are inputted to the XOR circuit 15S3, respectively. Each of the XOR circuits 1592 and 1593 outputs the inputted random number sequence while keeping a bit thereof in situ when the bit-to-be-inverted selection signal is “0”, whereas outputs the inputted random number sequence by inverting the bit thereof when the bit-to-be-inverted selection signal is “1”. The first, random number sequence 58a and the fourth random number sequence 58d which are not inputted to the XOR circuit 1592 or 1593 are respectively outputted in situ as bits of the multi-level code sequence. In this case, at least one of the bit-to-be-inverted selection signals is a value “1”.

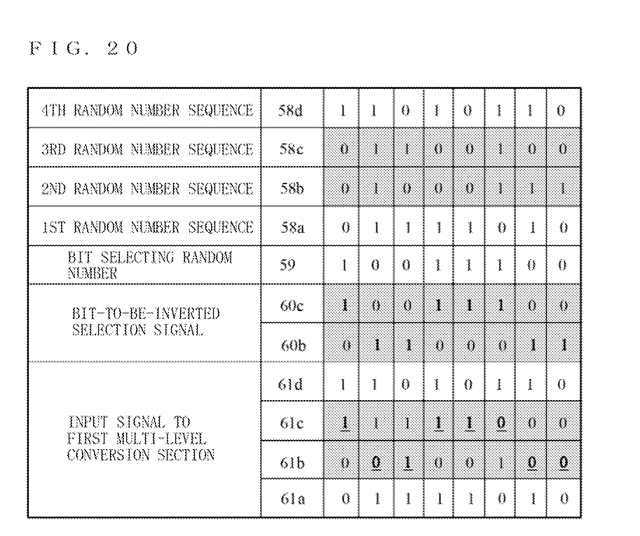

With reference to FIG. 20, an operation of the first multi-level code generation section 162a will be described in detail. First, an example will foe considered in which values of the first to fourth random number sequences 53a, 58b, 58c and 58d respectively outputted from the first random number sequence generation section 157, and a value of the bit-selecting random number 59 outputted from the bit-selecting random number generation section 1581 are as those shown in FIG. 20. The selection signal conversion section 1582 sets “1” to the bit-to-be-inverted selection signal 60b when the value of the bit selection signal 59 to be inputted is “0”, whereas sets “1” to the “bit-to-be-inverted selection signal 60c when the value of the bit-selecting random number 59 to foe inputted is “1”. The random number sequence bit inversion section 159 performs the bit inversion on and then outputs the second random number sequence 58b when the value of the bit-to-be-inverted selection signal 60b is “1”, whereas outputs in situ the second random number sequence 58b when the value of the bit-to-be-inverted selection signal 60b is “0”. The random number sequence bit inversion section 159 perform the bit inversion, on and then outputs the third random number sequence 58c when the value of the bit-to-be-inverted selection signal 60c is “1”, whereas outputs in situ the third random number sequence 58c when the value of the bit-to-be-inverted selection signal 60c is “0”. In this case, values of the bit-to-be-inverted selection signals 60b and 60c, and values of the first to fourth random number sequences 51a, 61b, 61c and 61d obtained as a result of the bit inversion are as those shown in FIG. 20.

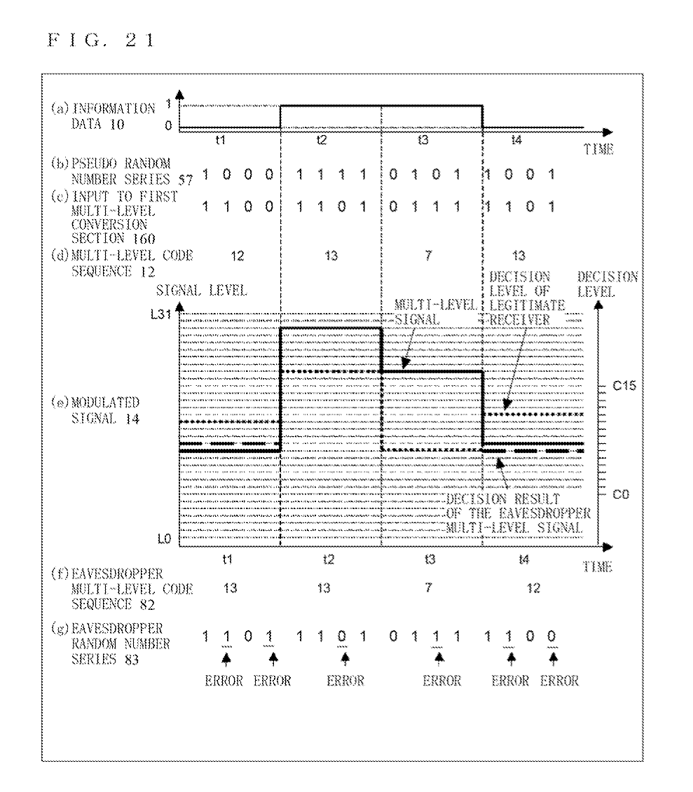

Next, a method of generating the multi-level signal 13 by using the multi-level code sequence 12 will foe described. FIG. 21 is a diagram showing waveforms of signals transmitted through the data communication apparatus according to the sixth embodiment of the present invention. A case where the information data 11 takes values as shown in FIG. 21(a) will foe considered. When the pseudo random number series 57 outputted from the pseudo random number generation section 1571 takes values as shown in FIG. 21(b), the values of the multi-level code sequence 12 are as those shown in FIG. 21(d) in accordance with a procedure described with reference to FIG. 20. The multi-level processing section 111b inputs thereto the multi-level code sequence 12 and the information data 10, and combines both of the signals in accordance with a predetermined procedure so as to generate the multi-level signal 13 having a level corresponding to the combination of both of the signals. In an example shown in FIG. 21, values “0, 1, 1, 0” of the information data are respectively multiplied by 16 times, and then added thereto are values “12, 13, 7, 13” of the multi-level code sequence 12, whereby the multi-level signal 13 is outputted.

Next, eavesdropping of the modulated signal 14 by a third party will foe described. In the present embodiment as well, it is assumed that the eavesdropper simultaneously performs decision of all the levels of the multi-level signal by using a receiving apparatus shown in FIG. 14 so as to attempt to extract key information. In this case, a result of multi-level decision of the eavesdropper multi-level signal, 81 performed by the eavesdropper contains an error caused by the quantum fluctuation as compared with levels of an original multi-level signal, as shown in FIG. 21(e). When erroneous dec is ion caused by the quantum fluctuation occurs in adjoining levels of the multi-level signal, an error occurs in a lowest-order bit of the eavesdropper multi-level code sequence 82. On the other hand, an error caused by the bit inversion, which is performed on the random, number sequence at a transmission end, occurs in the second and third lowest-order bits of the eavesdropper multi-level, code sequence 82, and thus the error is not offset by the error which occurs in the lowest-order bit and is caused by the quantum fluctuation. The eavesdropper random, number series 82 (represented in decimal form) obtained as a result of the decision is shown in FIG. 21(f), and the eavesdropper random number series 33 is shown in FIG. 21(g).

Actually, since a position at which the eavesdropper is to per form eavesdropping cannot be identified, a receiving level of the eavesdropper may be any level as long as the receiving level is equal to or lower than a transmission level. That is, it needs to be assumed that the possibility of error occurrence caused by the quantum fluctuation may be minimum when the receiving level is the same as the transmission level, and may take various values. The present embodiment is effective on such a case.

The bit inversion method as above described is merely an example. The number of the random number sequences subject to the bit inversion, and a correspondence relation between the value of the bit-selecting random number 59 and a bit to be inverted may be set arbitrarily, as long as the condition is satisfied that at least one of the first to fourth random number sequences 58a, 58b, 58c and 58d, except for the first random number sequence which corresponds to the lowest-order bit of the multi-level code sequence 12, is surely inverted. The number of bits of each of the random number sequences 58 an 61 is not limited, to 4 bits, but may be set arbitrarily.

Further, in the present embodiment, in the same manner as the fifth embodiment, the difference between the multi-level code sequence 12 used in the data transmitting apparatus 24105 and the multi-level code sequence 17 used in the data receiving apparatus 24205 has the effect as the deterioration in the SN ratio at the time of decision, and thus the difference needs to be set such that the deteriorated SN ratio satisfies a required value of the data receiving apparatus 24205. That is, a condition is satisfied that the ratio between the information amplitude and a fluctuation range of the multi-level signal, which is equivalent to the random number sequence subject to be selected for the bit inversion, is greater than the SN ratio permissible by a legitimate receiving party. Alternatively, as with the case described with reference to FIG. 15, an error correcting code may be applied to the information data.

As above described, according to the present embodiment, decryption of the key information by the eavesdropper can be prevented regardless of the magnitude of the quantum fluctuation, and thus it is possible to realise the same effect as the fifth embodiment, in a further versatile manner.

### Seventh Embodiment

A configuration and an operation of a data communication apparatus according to a seventh embodiment of the present invention are basically the same as those described in the fifth embodiment with reference to FIGS. 8 to 13. A difference between the present invention and the fifth embodiment is that the numbers of bits of the multi-level code sequence 12 and the multi-level code sequence 17 are set equal to or lower than the numbers of the bits of the first key information 11 and the second key information 16, respectively. Hereinafter, a significance thereof will be described.

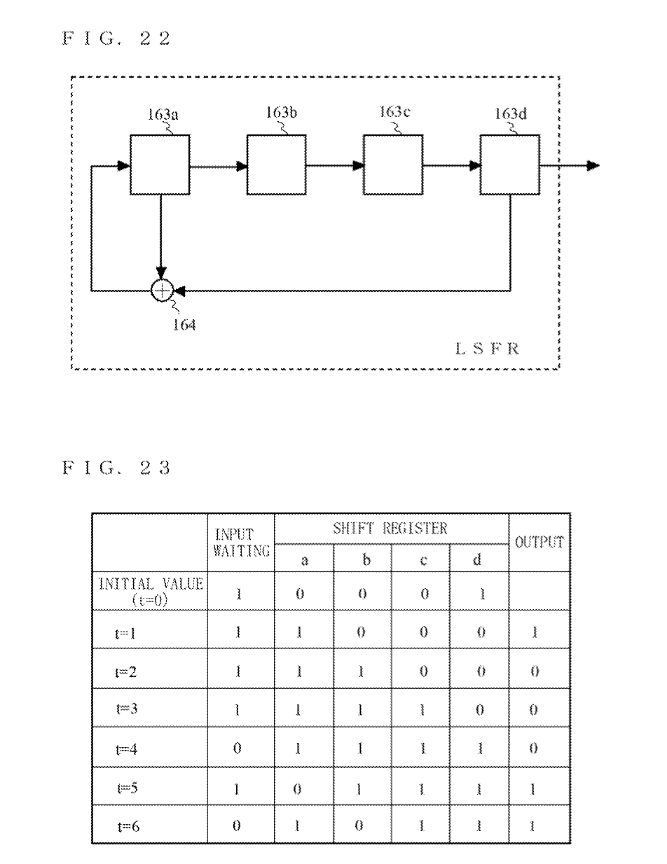

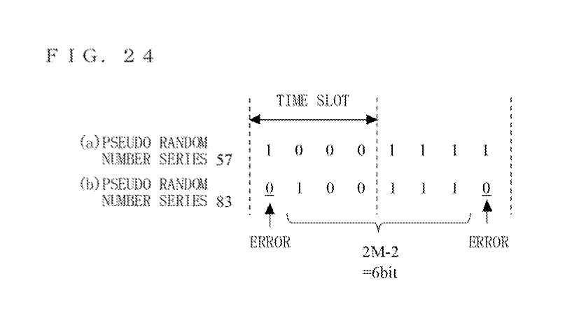

A Linear Feedback Shift Register (hereinafter abbreviated as an LFSR) typifies one of the simplest configurations of pseudo random number generators. FIG. 22 is a Mock diagram showing an exemplary configuration of the LFSR. FIG. 23 is a diagram showing an exemplary output of the LFSR. Each of the diagrams shows a case where initial values (corresponding to key information) are composed of 4 bits. As shown in FIG. 22, the LFSR is composed of shift registers 163a, 163b, 163c and 163d, and an XOR circuit 164. An operation of the LFSR will be described by using FIGS. 22 and 23 as examples. The given initial values “1, 0, 0, 1” are set to each of the shift registers 163a, 163b, 163c and 163d. A value “1”, which is obtained by performing an XOR operation between the values set to the shift registers 163a and 163d, represents an input waiting state. At the next timing, a value “1” set to the shift register 163d is outputted, and values “1 0 0” respectively set to the shift registers 163a, 163b and 163c are, in turn, shifted to the shift register 163b, 163c and 163d immediately on the right side thereof, respectively. The value “1” representing the input waiting state is set to the shift register 163a. The operation is repeated thereafter, whereby the LFSR outputs the pseudo random number series.

The LFSR has a cycle of 2^{k}−1 bits, when the number of bits of the initial values is k, and is capable of generating pseudo random numbers although the configuration thereof is simple. Therefore, the LFSR is used extensively for a communication system using a CDMA and the like. However, in the case of the LFSR, the initial values can be identified when consecutive 2 k bits having been outputted are obtained (see non-patent document 1 pp. 423), and thus the LFSR is not used as a pseudo random number generator for mathematical encryption.

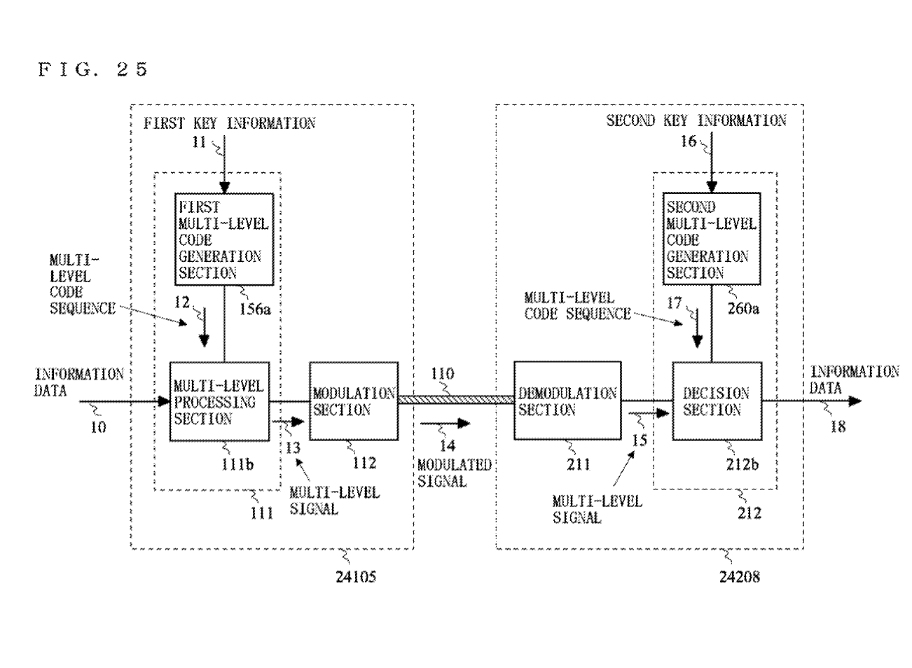

Identification of the initial values of the LFSR as above described is on the premise of a case where there is no error in the pseudo random number series to be outputted. Therefore, if an error is inevitably included in the consecutive 2 k bits, the initial values cannot be identified. Here, in FIGS. 9 and 10, it is assumed that the LFSR is used for the first random number sequence generation section 157 (pseudo random number generation section 1571) and the second random number sequence generation section 257, and that the eavesdropper simultaneously performs decision of all the levels of the multi-level signal by using the eavesdropper receiving apparatus as shown in FIG. 14 so as to attempt to extract the key information, in the same manner as the fifth embodiment. When the number of bits of the multi-level code sequence 12 is M, the eavesdropper random number series 83 inevitably includes at least one error bit among the M bits compared to the pseudo random number series 57. The number of consecutive bits free from an error reaches a maximum when, as shown in an example (a case of M=4) of FIG. 24, all the bits are subject to be selected for the bit inversion, the highest-order bit is inverted in a time slot, and the lowest-order bit is inverted in the subsequent time slot. In this case, the number of consecutive bits which are free from any error is 2M−2 bits. If 2M−2 is lower than 2 k, the eavesdropper cannot identify the initial values of the LFSR. Since M and R are natural numbers, respectively, a condition in which the eavesdropper cannot identify the initial value is indicated by the following equation 1.

M≦k (Equation 1)

That is, when M, i.e., the number of bits of the multi-level code sequence 12, is set equal to or lower than k, i.e., the number of bits of the first key information 11, the LFSR whose configuration is simple can be used for the pseudo random number generation section 1571 in the data communication apparatus according to the present embodiment.

Equation 1 is a condition necessary for the LFSR to be used, however, the use of the LFSR is not an essential condition. That is, when the condition of equation 1 is satisfied, another type of pseudo random number generator may be used for the pseudo random number generation section 1571. In that, case, the number of bits, which are necessary to identify the initial values of the pseudo random, number generator, needs to be equal to or greater than 2 k bits.

As above described, according to the present embodiment, unlike the conventional mathematical encryption, it is possible to use the pseudo random number generator having a simple configuration such as the LFSR.

### Eighth Embodiment

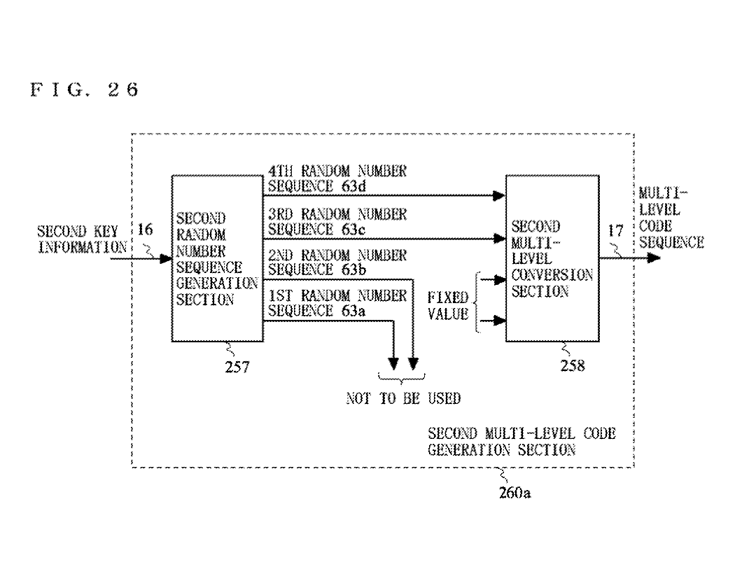

FIG. 25 is a block diagram showing an exemplary configuration of a data command cat ion apparatus according to an eighth embodiment of the present invention. As shown in FIG. 25, an overall configuration of the data communication apparatus according to the eighth embodiment of the present invention is basically the same as that according to the fifth embodiment (FIG. 8), and only a configuration of a second multi-level code generation section 260a is different. A configuration and an operation of a first multi-level code generation section 156a is the same as those described with reference to FIG. 9 or 11, and FIG. 12. Hereinafter, a difference between the pre sent embodiment and the fifth embodiment will be mainly described. Description of such functional blocks that perform the same operation as those in the fifth embodiment will be omitted.

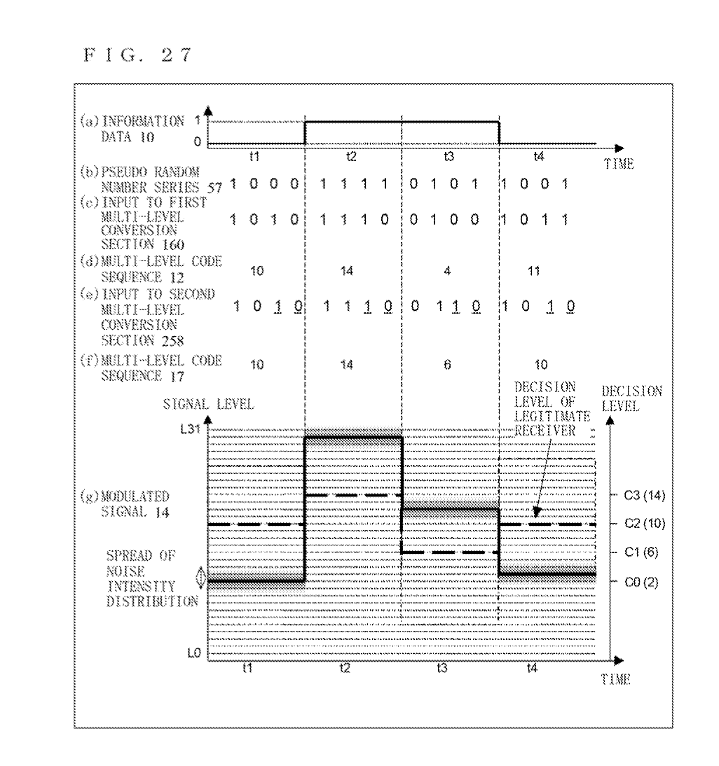

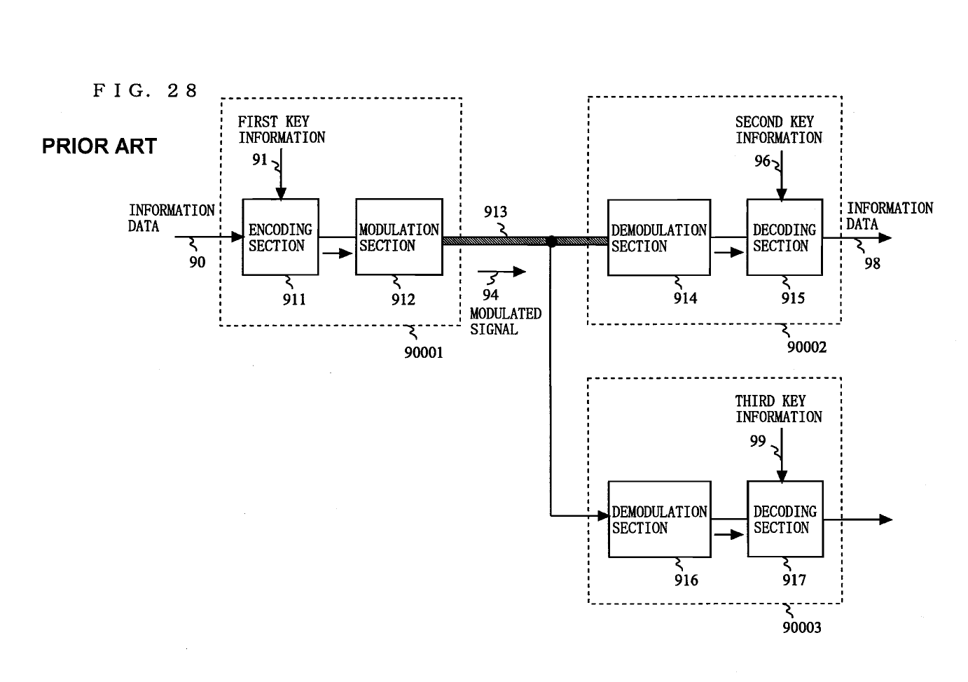

The present embodiment is different from the fifth embodiment in a setting method of the decision level in a data receiving apparatus 24208. FIG. 26 is a block diagram showing an exemplary configuration of the second multi-level code generation section 260a according to the eighth embodiment of the present invention. As shown in FIG. 26, the second multi-level code generation section 260a according to the present embodiment only uses the third random number sequence 63c and the fourth random number sequence 63d among the first to fourth random number sequences 63a, 63b, 63c and 63d, and does not use the first random number sequence 63a and the second random number sequence 63b. These first random number sequence 63a and the second random number sequence 63b are equivalent to the first random number sequence 58a and the second random number sequence 58b, which are subject to be selected for the bit inversion, in the first multi-level code generation section 156a. A function of the second random number sequence generation section 257 is the same as that described in the fifth embodiment (FIG. 10).

To the second multi-level conversion section 258, the third random number sequence 63c and the fourth random number sequence 63d are inputted as high-order bits, and fixed values are inputted as low-order bits. The second multi-level conversion section 258 converts the inputted bit sequence into the multi-level code sequence 17 and then outputs the same. Among the random number sequences generated on the transmission side, the first random number sequence 58a and the second random number sequence 58b are subject to the bit inversion, and thus are highly likely to contain errors. However, an effect of the errors on the SNR is insignificant. Therefore, even if the decision level is determined in the second multi-level conversion section 60a while level changes in the first random number sequence 63a and the second random number sequence 63b are ignored, the first random number sequence 63a and the second random number sequence 63b corresponding to the first random number sequence 58a and the second random number sequence 58b, respectively, the determination hardly exerts a negative effect on reception performance of a legitimate receiving party.

FIG. 27 is a diagram illustrating waveforms of signals transmitted through the data communication apparatus according to the eighth embodiment of the present invention. With reference to FIG. 27, a setting method of the decision level according to the eighth embodiment of the present invention will be described (a) to (d) of FIG. 27 is the same as FIG. 13, and thus description thereof will be omitted. To the second multi-level conversion section 258, as shown in FIG. 27(e), values of the third random number sequence 63c and the fourth random number sequence 63d are inputted as high-order bits, and fixed values (“1, 0” in this case) are inputted as low-order bits. In this case, values of the multi-level code sequence 17 are as shown in FIG. 27(f). Therefore, the decision level used in the decision section 212b is selected from among four levels C0 to C3 (corresponding values of the multi-level code sequence 17 represented in parentheses) as shown in FIG. 27(g). In the case where the values of the multi-level code sequence 17 are as shown in FIG. 27(f), the decision level changes as shown by dashed lines in FIG. 27(g).

Next, a guideline for selecting a random number sequence to be inputted to the second multi-level conversion section 233 will be described. A fluctuation range of the decision level, which is equivalent to a random number sequence not to be used (first and second random number sequences 63a and 63b in this case), acts as inaccuracy of the decision level at time of decision, and has the same effect as the deterioration in a signal level. That is, the random number sequence not to be used has the effect as the deterioration in the SN ratio. Accordingly, the data communication apparatus according to the eighth embodiment selects the random number sequence to foe inputted to the second multi-level conversion section 233 such that the deteriorated SN ratio satisfies a required value of the data receiving apparatus 24208. Specifically, the data communication apparatus according to the eighth embodiment needs to select the random number sequence to be inputted to the second multi-level conversion section 258 so as to satisfy a condition that a ratio between the information amplitude and the fluctuation range of the decision level, which is equivalent to the random number sequence not to be used, is greater than the SN ratio permissible by a legitimate receiving party.

In each of FIGS. 26 and 27, the total number of bits of the multi-level code sequence 17 is 4, and the number of bits to which fixed values are inputted, is 2. These are merely examples, and as long as the above-described, condition is satisfied, other values may be applied. Further, values “1, 0” are used as the fixed, values to be inputted as the low-order bits in the second multi-level conversion section 258, but are merely examples, and may foe replaced with any other values. Alternatively, input to the low-order bits may be omitted by using the multi-level conversion section 258 which uses a less number of bits.

As above described, according to the present embodiment, since a smaller number of levels of the multi-level code sequence 17 needs to be set, it is possible to simplify the configuration of the data receiving apparatus 24205.

### INDUSTRIAL APPLICABILITY

The data communication apparatus according to the present invention is useful as a secret communication apparatus or the like which is safe and insusceptible to eavesdropping/interception or the like.

1. A data transmitting apparatus for performing cipher communication, comprising:
a multi-level encoding section for inputting thereto predetermined key information and information data, and for generating a multi-level signal in which a signal level changes so as to be approximately random numbers; and
a modulation section for generating a modulated signal in a predetermined modulation format in accordance with the multi-level signal, wherein
the multi-level encoding section includes:
a multi-level code generation section for generating, by using the predetermined key information, a multi-level code sequence in which a signal level changes so as to be approximately random numbers; and
a multi-level processing section for combining the multi-level code sequence and the information data in accordance with predetermined processing, and for generating the multi-level signal having a level corresponding to a combination of the signal level of the multi-level code sequence and a signal level of the information data,
the multi-level code generation section includes:
a random number generation section for generating a plurality of random number sequences by using the predetermined key information;
a bit-to-be-inverted selection section for outputting a bit-to-be-inverted selection signal for selecting a random number sequence on which a bit inversion is to be performed, from among the plurality of random number sequences;
a random number sequence bit inversion section for outputting one or more random number sequences by performing the bit inversion thereof, among the plurality of the random number sequences, in accordance with a value of the bit-to-be-inverted selection signal; and
a multi-level conversion section for converting the plurality of random number sequences, including the random number sequence on which the bit inversion has been performed, into the multi-level code sequence.

2. The data transmitting apparatus according to claim 1, wherein a bit to be inverted in the random number sequence bit inversion section satisfies a condition that a ratio between an information amplitude, which is equivalent, to an amplitude of the information data, and a fluctuation range of the multi-level signal, which is equivalent to the bit to be inverted, is greater than a signal-to-noise ratio permissible by a legitimate receiving party.

3. The data transmitting apparatus according to claim 1, wherein the bit to be inverted in the random number sequence bit inversion section is selected from among bits except for a lowest-order bit.

4. The data transmitting apparatus according to claim 1, wherein the bit-to-be-inverted selection section includes:
a random number generation section for generating bit-selecting random numbers which are predetermined random numbers; and
a selection signal conversion section for converting the bit-selecting random numbers into the bit-to-be-inverted selection signal in accordance with values of the bit-selecting random numbers.

5. The data transmitting apparatus according to claim 4, wherein the bit-selecting random numbers generated in the random number generation section are genuine random numbers.

6. The data transmitting apparatus according to claim 1, wherein the number of bits of the multi-level code sequence is set equal to or lower than the number of bits of the key information.

7. A data receiving apparatus for performing cipher communication, comprising:
a demodulation section for demodulating a modulated signal in a predetermined modulation format, and for outputting a multi-level signal; and
a multi-level decoding section for outputting information data in accordance with predetermined key information and the multi-level signal, wherein
the multi-level decoding section includes:
a multi-level code generation section for generating, by using the key information, a multi-level code sequence in which a signal level changes so as to be approximately random numbers; and
a decision section for deciding the multi-level signal in accordance with the multi-level code sequence, and for outputting the information data,
the multi-level code generation section includes:
a random number generation section for generating a plurality of random number sequences by using the predetermined key information; and
a multi-level conversion section for converting the plurality of random number sequences into the multi-level code sequence.

8. The data receiving apparatus according to claim 7, wherein, to the multi-level conversion section, a higher-order bit of the plurality of random number sequences is inputted, and a fixed value is inputted as a low-order bit.

9. The data receiving apparatus according to claim 8, wherein a ratio between information amplitude, which is equivalent to an amplitude of the information data, and a fluctuation range of the multi-level signal, which is equivalent to the low-order bit, satisfies a condition of being greater than a signal-to-noise ratio permissible by a legitimate receiving party.
